(19) United States
(12) Patent Application Publication
(10) Pub. No.: US 2025/0055502 A1
(43) Pub. Date: Feb. 13, 2025

(54) MULTI-ARRAY DESIGN FOR BINARY BEAM ACQUISITION OF RECONFIGURABLE INTELLIGENT SURFACES

(71) Applicant: QUALCOMM Incorporated, San Diego, CA (US)

(72) Inventors: Saeid SAHRAEI, San Diego, CA (US); Krishna Kiran MUKKAVILLI, San Diego, CA (US); Yu ZHANG, San Diego, CA (US); Peter GAAL, San Diego, CA (US); Wanshi CHEN, San Diego, CA (US); Hung Dinh LY, San Diego, CA (US)

(21) Appl. No.: 18/719,666

(22) PCT Filed: Feb. 21, 2022
(86) PCT No.: PCT/CN2022/077025

§ 371 Date: Jun. 13, 2024

(51) Int. Cl. H04B 7/04; H04L 5/00

(52) U.S. Cl. CPC H04B 7/04013; H04L 5/005

(57) ABSTRACT

Methods, systems, and devices for wireless communications are described. The method includes receiving, from a network entity at a control unit associated with a reconfigurable intelligent surface, a set of multiple reference signals via a set of multiple receive beams, acquiring, via a first antenna panel associated with the control unit, a first beam of the set of multiple receive beams, acquiring, via a second antenna panel associated with the control unit, a second beam of the set of multiple receive beams, determining reflection coefficients of the reconfigurable intelligent surface for communication with the network entity based on the acquiring of the first beam and the acquiring of the second beam, and communicating via the reconfigurable intelligent surface based on the reflection coefficients of the reconfigurable intelligent surface.

### CROSS REFERENCE

The present Application is a 371 national phase filing of International PCT Application No. PCT/CN2022/077025 by SAHRAEI et al., entitled “MULTI-ARRAY DESIGN FOR BINARY BEAM ACQUISITION OF RECONFIGURABLE INTELLIGENT SURFACES,” filed Feb. 21, 2022, which is assigned to the assignee hereof, and which is expressly incorporated by reference in its entirety herein.

### FIELD OF TECHNOLOGY

The following relates to wireless communications, including multi-array design for binary beam acquisition of reconfigurable intelligent surfaces.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support multi-array design for binary beam acquisition of reconfigurable intelligent surfaces. In some systems, two or more devices may communicate with each other via a reflective surface. For example, a first device may transmit signaling toward the reflective surface and a second device may receive the signaling reflected off the reflective surface. The described techniques provide for incorporating active antenna panels with a reconfigurable intelligent surface to enable a control unit associated with the reconfigurable intelligent surface to perform multi-array beam acquisition techniques at the reconfigurable intelligent surface and, based on the multi-array beam acquisition techniques, to configure the reconfigurable intelligent surface (e.g., configure a beam of the reconfigurable intelligent surface towards a network entity or user equipment). In some cases, the control unit may be configured with two or more independent active antenna panels, where a respective radio frequency (RF) chain may be configured for each active antenna panel. In some cases, each active antenna panel may be configured with a receive capability, and in some cases each active antenna panel may be configured with a transmit and receive capability. A first active antenna panel may be used for a first level of beam acquisition (e.g., general such as a wide beam acquisition), while a second active antenna panel may be used for a second level of beam acquisition (e.g., narrow such as a refined beam acquisition).

A method for wireless communication is described. The method may include receiving, from a network entity at a control unit associated with a reconfigurable intelligent surface, a set of multiple reference signals via a set of multiple receive beams, acquiring, via a first antenna panel associated with the control unit, a first beam of the set of multiple receive beams, acquiring, via a second antenna panel associated with the control unit, a second beam of the set of multiple receive beams, determining reflection coefficients of the reconfigurable intelligent surface for communication with the network entity based on the acquiring of the first beam and the acquiring of the second beam, and communicating via the reconfigurable intelligent surface based on the reflection coefficients of the reconfigurable intelligent surface.

An apparatus for wireless communication is described. The apparatus may include a processor, memory coupled with the processor, and instructions stored in the memory. The instructions may be executable by the processor to cause the apparatus to receive, from a network entity at a control unit associated with a reconfigurable intelligent surface, a set of multiple reference signals via a set of multiple receive beams, acquire, via a first antenna panel associated with the control unit, a first beam of the set of multiple receive beams, acquire, via a second antenna panel associated with the control unit, a second beam of the set of multiple receive beams, determine reflection coefficients of the reconfigurable intelligent surface for communication with the network entity based on the acquiring of the first beam and the acquiring of the second beam, and communicate via the reconfigurable intelligent surface based on the reflection coefficients of the reconfigurable intelligent surface.

Another apparatus for wireless communication is described. The apparatus may include means for receiving, from a network entity at a control unit associated with a reconfigurable intelligent surface, a set of multiple reference signals via a set of multiple receive beams, means for acquiring, via a first antenna panel associated with the control unit, a first beam of the set of multiple receive beams, means for acquiring, via a second antenna panel associated with the control unit, a second beam of the set of multiple receive beams, means for determining reflection coefficients of the reconfigurable intelligent surface for communication with the network entity based on the acquiring of the first beam and the acquiring of the second beam, and means for communicating via the reconfigurable intelligent surface based on the reflection coefficients of the reconfigurable intelligent surface.

A non-transitory computer-readable medium storing code for wireless communication is described. The code may include instructions executable by a processor to receive, from a network entity at a control unit associated with a reconfigurable intelligent surface, a set of multiple reference signals via a set of multiple receive beams, acquire, via a first antenna panel associated with the control unit, a first beam of the set of multiple receive beams, acquire, via a second antenna panel associated with the control unit, a second beam of the set of multiple receive beams, determine reflection coefficients of the reconfigurable intelligent surface for communication with the network entity based on the acquiring of the first beam and the acquiring of the second beam, and communicate via the reconfigurable intelligent surface based on the reflection coefficients of the reconfigurable intelligent surface.

Some examples of the method, apparatuses, and non-transitory computer-readable medium described herein may further include operations, features, means, or instructions for superposing the first beam in relation to the second beam, where determining the reflection coefficients may be based on identifying a beam of the reconfigurable intelligent surface that corresponds to the superposing of the first beam and the second beam.

Some examples of the method, apparatuses, and non-transitory computer-readable medium described herein may further include operations, features, means, or instructions for receiving, prior to receiving the set of multiple reference signals and based on the superposing of the first beam and the second beam, a channel state information reference signal resource set indicating a repetition parameter set to on and a reporting parameter set to off, where the set of multiple reference signals include a set of multiple channel state information reference signals.

Some examples of the method, apparatuses, and non-transitory computer-readable medium described herein may further include operations, features, means, or instructions for performing, via the first antenna panel and the second antenna panel and based on the channel state information reference signal resource set, beam sweep measurements on the set of multiple reference signals received concurrently at the first antenna panel and at the second antenna panel, where the acquiring of the first beam and the acquiring of the second beam may be based on the beam sweep measurements.

In some examples of the method, apparatuses, and non-transitory computer-readable medium described herein, the first antenna panel includes a narrow panel configuration with a first inter-element spacing and the second antenna panel includes a wide panel configuration with a second inter-element spacing, the second inter-element spacing being larger than the first inter-element spacing.

In some examples of the method, apparatuses, and non-transitory computer-readable medium described herein, the first inter-element spacing and the second inter-element spacing may be larger than an inter-element spacing of an antenna panel of the reconfigurable intelligent surface.

In some examples of the method, apparatuses, and non-transitory computer-readable medium described herein, the control unit includes a first radio frequency chain for the first antenna panel and a second radio frequency chain for the second antenna panel.

In some examples of the method, apparatuses, and non-transitory computer-readable medium described herein, the first antenna panel and the second antenna panel may have fewer antenna elements than an antenna panel of the reconfigurable intelligent surface.

In some examples of the method, apparatuses, and non-transitory computer-readable medium described herein, the first antenna panel or the second antenna panel, or both, may have receiver capability or may have receiver capability and transmitter capability.

In some examples of the method, apparatuses, and non-transitory computer-readable medium described herein, the control unit of the reconfigurable intelligent surface includes logarithm N sub-arrays, each sub-array including multiple antenna elements that may be configured in different directions.

In some examples of the method, apparatuses, and non-transitory computer-readable medium described herein, the reconfigurable intelligent surface may be configured with a number of elements determined based on a value of N squared, a number of antennas at the control unit may be based on a base-2 logarithm of N, and the antennas at the control unit configure the number of elements at the reconfigurable intelligent surface.

A method for wireless communication is described. The method may include receiving, at a network entity, a set of multiple reference signals transmitted from a control unit associated with a reconfigurable intelligent surface via a set of multiple beams, selecting a first beam of the set of multiple beams for a first antenna panel associated with the control unit, selecting a second beam of the set of multiple beams for a second antenna panel associated with the control unit, and signaling, to the control unit, a configuration of the reconfigurable intelligent surface determined based on the first beam and the second beam.

An apparatus for wireless communication is described. The apparatus may include a processor, memory coupled with the processor, and instructions stored in the memory. The instructions may be executable by the processor to cause the apparatus to receive, at a network entity, a set of multiple reference signals transmitted from a control unit associated with a reconfigurable intelligent surface via a set of multiple beams, select a first beam of the set of multiple beams for a first antenna panel associated with the control unit, select a second beam of the set of multiple beams for a second antenna panel associated with the control unit, and signal, to the control unit, a configuration of the reconfigurable intelligent surface determined based on the first beam and the second beam.

Another apparatus for wireless communication is described. The apparatus may include means for receiving, at a network entity, a set of multiple reference signals transmitted from a control unit associated with a reconfigurable intelligent surface via a set of multiple beams, means for selecting a first beam of the set of multiple beams for a first antenna panel associated with the control unit, means for selecting a second beam of the set of multiple beams for a second antenna panel associated with the control unit, and means for signaling, to the control unit, a configuration of the reconfigurable intelligent surface determined based on the first beam and the second beam.

A non-transitory computer-readable medium storing code for wireless communication is described. The code may include instructions executable by a processor to receive, at a network entity, a set of multiple reference signals transmitted from a control unit associated with a reconfigurable intelligent surface via a set of multiple beams, select a first beam of the set of multiple beams for a first antenna panel associated with the control unit, select a second beam of the set of multiple beams for a second antenna panel associated with the control unit, and signal, to the control unit, a configuration of the reconfigurable intelligent surface determined based on the first beam and the second beam.

In some examples of the method, apparatuses, and non-transitory computer-readable medium described herein, the configuration of the reconfigurable intelligent surface includes reflection coefficients associated with the first antenna panel, reflection coefficients associated with the second antenna panel, a first transmit precoding matrix index associated with the first antenna panel, a second transmit precoding matrix index associated with the second antenna panel, or a transmit precoding matrix index associated with the reconfigurable intelligent surface, or any combination thereof.

Some examples of the method, apparatuses, and non-transitory computer-readable medium described herein may further include operations, features, means, or instructions for receiving, prior to receiving the set of multiple reference signals, a configuration of the first antenna panel and the second antenna panel and a configuration of the reconfigurable intelligent surface.

Some examples of the method, apparatuses, and non-transitory computer-readable medium described herein may further include operations, features, means, or instructions for transmitting, to the control unit based on receiving the configuration of the first antenna panel and the second antenna panel, a first sounding reference signal resource set that indicates uplink beam management associated with the first antenna panel and a second sounding reference signal resource set that indicates uplink beam management associated with the second antenna panel.

In some examples of the method, apparatuses, and non-transitory computer-readable medium described herein, the configuration of the first antenna panel and the second antenna panel indicate an inter-element spacing of the first antenna panel, an inter-element spacing of the second antenna panel, a number of antennas associated with the first antenna panel, or a number of antennas associated with the second antenna panel, or any combination thereof and the configuration of the reconfigurable intelligent surface indicates an inter-element spacing of elements associated with the reconfigurable intelligent surface, or a number of elements associated with the antenna panel of the reconfigurable intelligent surface, or both.

A method for wireless communication is described. The method may include transmitting, to a network entity from a control unit associated with a reconfigurable intelligent surface, a set of multiple reference signals including a first set of reference signals transmitted via a first antenna panel associated with the control unit and a second set of reference signals transmitted via a second antenna panel associated with the control unit, receiving, from the control unit, a configuration of the reconfigurable intelligent surface, and configuring the reconfigurable intelligent surface for communication with the network entity based on the configuration of the reconfigurable intelligent surface.

An apparatus for wireless communication is described. The apparatus may include a processor, memory coupled with the processor, and instructions stored in the memory. The instructions may be executable by the processor to cause the apparatus to transmit, to a network entity from a control unit associated with a reconfigurable intelligent surface, a set of multiple reference signals including a first set of reference signals transmitted via a first antenna panel associated with the control unit and a second set of reference signals transmitted via a second antenna panel associated with the control unit, receive, from the control unit, a configuration of the reconfigurable intelligent surface, and configure the reconfigurable intelligent surface for communication with the network entity based on the configuration of the reconfigurable intelligent surface.

Another apparatus for wireless communication is described. The apparatus may include means for transmitting, to a network entity from a control unit associated with a reconfigurable intelligent surface, a set of multiple reference signals including a first set of reference signals transmitted via a first antenna panel associated with the control unit and a second set of reference signals transmitted via a second antenna panel associated with the control unit, means for receiving, from the control unit, a configuration of the reconfigurable intelligent surface, and means for configuring the reconfigurable intelligent surface for communication with the network entity based on the configuration of the reconfigurable intelligent surface.

A non-transitory computer-readable medium storing code for wireless communication is described. The code may include instructions executable by a processor to transmit, to a network entity from a control unit associated with a reconfigurable intelligent surface, a set of multiple reference signals including a first set of reference signals transmitted via a first antenna panel associated with the control unit and a second set of reference signals transmitted via a second antenna panel associated with the control unit, receive, from the control unit, a configuration of the reconfigurable intelligent surface, and configure the reconfigurable intelligent surface for communication with the network entity based on the configuration of the reconfigurable intelligent surface.

In some examples of the method, apparatuses, and non-transitory computer-readable medium described herein, the configuration of the reconfigurable intelligent surface includes reflection coefficients associated with the first antenna panel, reflection coefficients associated with the second antenna panel, a first transmit precoding matrix index associated with the first antenna panel, a second transmit precoding matrix index associated with the second antenna panel, or a transmit precoding matrix index associated with the reconfigurable intelligent surface, or any combination thereof.

Some examples of the method, apparatuses, and non-transitory computer-readable medium described herein may further include operations, features, means, or instructions for transmitting, prior to receiving the set of multiple reference signals, a configuration of the first antenna panel and the second antenna panel and a configuration of the reconfigurable intelligent surface.

Some examples of the method, apparatuses, and non-transitory computer-readable medium described herein may further include operations, features, means, or instructions for receiving, from the network entity based on transmitting the configuration of the first antenna panel and the second antenna panel, a first sounding reference signal resource set that indicates uplink beam management associated with the first antenna panel and a second sounding reference signal resource set that indicates uplink beam management associated with the second antenna panel.

In some examples of the method, apparatuses, and non-transitory computer-readable medium described herein, the configuration of the first antenna panel and the second antenna panel indicate an inter-element spacing of the first antenna panel, an inter-element spacing of the second antenna panel, a number of antennas associated with the first antenna panel, or a number of antennas associated with the second antenna panel, or any combination thereof and the configuration of the reconfigurable intelligent surface indicates an inter-element spacing of elements associated with the reconfigurable intelligent surface, or a number of elements associated with the antenna panel of the reconfigurable intelligent surface, or both.

### BRIEF DESCRIPTION OF THE DRAWINGS

FIG. 1 illustrates an example of a wireless communications system that supports multi-array design for binary beam acquisition of reconfigurable intelligent surfaces in accordance with one or more aspects of the present disclosure.

FIG. 2 illustrates an example of a wireless communications system that supports multi-array design for binary beam acquisition of reconfigurable intelligent surfaces in accordance with one or more aspects of the present disclosure.

FIG. 3 illustrates an example of a wireless communications system that supports multi-array design for binary beam acquisition of reconfigurable intelligent surfaces in accordance with one or more aspects of the present disclosure.

FIG. 4 illustrates an example of a wireless communications system that supports multi-array design for binary beam acquisition of reconfigurable intelligent surfaces in accordance with one or more aspects of the present disclosure.

FIG. 5 illustrates an example of beam graphs that support multi-array design for binary beam acquisition of reconfigurable intelligent surfaces in accordance with one or more aspects of the present disclosure.

FIG. 6 illustrates an example of a reconfigurable intelligent surface that supports multi-array design for binary beam acquisition of reconfigurable intelligent surfaces in accordance with one or more aspects of the present disclosure.

FIG. 7 illustrates an example of a process flow that supports multi-array design for binary beam acquisition of reconfigurable intelligent surfaces in accordance with one or more aspects of the present disclosure.

FIG. 8 illustrates an example of a process flow that supports multi-array design for binary beam acquisition of reconfigurable intelligent surfaces in accordance with one or more aspects of the present disclosure.

FIG. 9 illustrates an example of a reconfigurable intelligent surface that supports multi-array design for binary beam acquisition of reconfigurable intelligent surfaces in accordance with one or more aspects of the present disclosure.

FIG. 10 illustrates an example of a reconfigurable intelligent surface that supports multi-array design for binary beam acquisition of reconfigurable intelligent surfaces in accordance with one or more aspects of the present disclosure.

FIGS. 11 and 12 show block diagrams of devices that support multi-array design for binary beam acquisition of reconfigurable intelligent surfaces in accordance with one or more aspects of the present disclosure.

FIG. 13 shows a block diagram of a communications manager that supports multi-array design for binary beam acquisition of reconfigurable intelligent surfaces in accordance with one or more aspects of the present disclosure.

FIG. 14 shows a diagram of a system including a device that supports multi-array design for binary beam acquisition of reconfigurable intelligent surfaces in accordance with one or more aspects of the present disclosure.

FIGS. 15 and 16 show block diagrams of devices that support multi-array design for binary beam acquisition of reconfigurable intelligent surfaces in accordance with one or more aspects of the present disclosure.

FIG. 17 shows a block diagram of a communications manager that supports multi-array design for binary beam acquisition of reconfigurable intelligent surfaces in accordance with one or more aspects of the present disclosure.

FIG. 18 shows a diagram of a system including a device that supports multi-array design for binary beam acquisition of reconfigurable intelligent surfaces in accordance with one or more aspects of the present disclosure.

FIGS. 19 through 21 show flowcharts illustrating methods that support multi-array design for binary beam acquisition of reconfigurable intelligent surfaces in accordance with one or more aspects of the present disclosure.

### DETAILED DESCRIPTION

The present techniques include multi-array beam acquisition for reconfigurable intelligent surfaces. A control unit for a reconfigurable intelligent surface may be configured with multiple (e.g., at least two) independent active antenna panels to enable a transmit and receive capability for the control unit. The independent active antenna panels may enable the control unit to configure a beam (or multiple beams) of the reconfigurable intelligent surface towards the network entity, or a UE, or both. A radio frequency chain may be configured for each antenna panel of the control unit. The antenna panels may be configured with relatively few antenna elements compared to the reflective elements on the surface of the reconfigurable intelligent surface. For instance, each antenna panel may have N antenna elements (e.g., N=2, 4, 8), while the surface of the reconfigurable intelligent surface may have tens or hundreds of reflective elements. Each antenna panel may be configured with a receive capability, and in some cases may be configured with a transmit and receive capability, while the surface of the reconfigurable intelligent surface may have a reflection capability via its reflective elements.

In some cases, the antenna panels may differ in inter-element spacing. In some cases, the antenna panels may differ in usage. A first antenna panel (e.g., a narrow panel) may be configured with a relatively narrow inter-element spacing (e.g., λ/2), and may be used for communication between the control unit and network entity. A second antenna panel (e.g., a wide panel) may be configured with a relatively wide inter-element spacing (e.g., Nλ/2), and may be used for refined beam acquisition. The wide panel may be configured to generate narrower beams (e.g., narrower discrete Fourier transform beams) compared to the narrow panel, but may have larger side-lobes than the narrow panel. In combination with the narrow panel, the wide panel may enable the control unit to acquire a relatively narrow beam suitable for the surface of the reconfigurable intelligent surface, where narrower beams are relatively more efficient than wider beams.

In some cases, a network entity may transmit multiple reference signals (e.g., multiple channel state information reference signals) to the control unit via multiple beams. The antenna panels of the control unit may sweep the multiple reference signals, analyze the sweep, and configure the reconfigurable intelligent surface with a relatively narrow beam towards the network entity based on the analysis. In some examples, the narrow panel of the control unit may acquire a first beam from the multiple beams, and the wide panel may acquire a second beam from the multiple beams. The control unit may configure a beam for the reconfigurable intelligent surface based on the beam acquired by the narrow panel and the beam acquired by the wide panel.

In some cases, the control unit may transmit multiple reference signals (e.g., multiple sounding reference signals) to the network unit via multiple beams transmitted by each of the antenna panels (e.g., narrow panel and wide panel). In some cases, the control unit may transmit information regarding a configuration of the antenna panels of the control unit or information regarding a configuration of the surface of the reconfigurable intelligent surface, or both. The network entity may sweep the multiple sounding reference signals transmitted by the control unit, analyze the sweep, generate a configuration that configures the reconfigurable intelligent surface with a relatively narrow beam towards the network entity based on the analysis, and signal the configuration to the control unit.

Aspects of the subject matter described herein may be implemented to realize one or more advantages. The described techniques may support improvements in system efficiency such that a device may improve one or more aspects of communication (e.g., increased signal quality, increased throughput, increased transmission efficiency, increased power savings) between a UE, a reconfigurable intelligent surface, and network entity, such as when an object blocks or otherwise inhibits a line-of-sight (LoS) link between the network entity and the UE. Additionally, described techniques may result in avoiding multiple retransmissions and failed transmissions, decreasing system latency, improving the reliability of transmissions between the UE and the network entity, and improving user experience

Aspects of the disclosure are initially described in the context of wireless communications systems. Aspects of the disclosure are further illustrated by and described with reference to beam analysis, reconfigurable intelligent surface configurations, and process flows that relate to multi-array beam acquisition for reconfigurable intelligent surfaces. Aspects of the disclosure are further illustrated by and described with reference to apparatus diagrams, system diagrams, and flowcharts that relate to multi-array beam acquisition for reconfigurable intelligent surfaces.

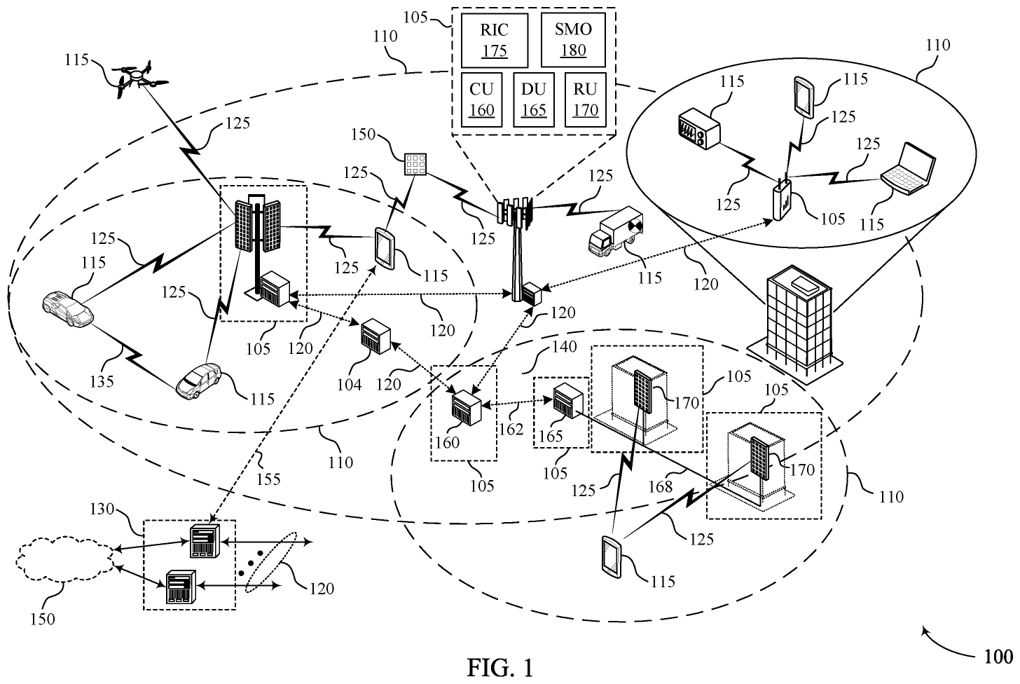

FIG. 1 illustrates an example of a wireless communications system 100 that supports multi-array design for binary beam acquisition of reconfigurable intelligent surfaces in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another over a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 through a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 175 is flexible and may support different functionalities depending upon which functions (e.g., network layer functions, protocol layer functions, baseband functions, RF functions, and any combinations thereof) are performed at a CU 160, a DU 165, or an RU 175. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication over such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support multi-array design for binary beam acquisition of reconfigurable intelligent surfaces as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) over one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both) such that the more resource elements that a device receives and the higher the order of the modulation scheme, the higher the data rate may be for the device. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be able to communicate directly with other UEs 115 over a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by or scheduled by the network entity 105. In some examples, one or more UEs 115 in such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without the involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, which may be referred to as clusters, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. While operating in unlicensed RF spectrum bands, devices such as the network entities 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located in diverse geographic locations. A network entity 105 may have an antenna array with a set of rows and columns of antenna ports that the network entity 105 may use to support beamforming of communications with a UE 115. Likewise, a UE 115 may have one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate over logical channels. A MAC layer may perform priority handling and multiplexing of logical channels into transport channels. The MAC layer may also use error detection techniques, error correction techniques, or both to support retransmissions at the MAC layer to improve link efficiency. In the control plane, the RRC protocol layer may provide establishment, configuration, and maintenance of an RRC connection between a UE 115 and a network entity 105 or a core network 130 supporting radio bearers for user plane data. At the PHY layer, transport channels may be mapped to physical channels.

In some deployment scenarios, direct beamforming between two devices (e.g., a UE 115 and network entity 105 of FIG. 1) may be insufficient and fail to support a reliable communication link between the two devices. In some of such deployment scenarios, the two devices may use an assisting device, such as a reconfigurable intelligent surface (RIS) 150, to support the communication link between the devices. In some cases, the RIS 150, which may be an example of a reflective surface, may be associated with a number of different configurations, where each of the different configurations corresponds to a unique pair of a receive beam at the RIS 150 and a reflected beam from the RIS 150.

To support an uplink signature procedure between two devices, such as between a network entity 105 and a UE 115, the RIS 150 may be divided into a number of sub-RISs (e.g., reflective elements), each sub-RIS configured to have a common receive beam oriented toward the network entity 105 and different reflected beams oriented toward potential locations of the UE 115. As part of the uplink signature procedure, the network entity 105 may transmit an SSB for each of a number of SSB beams and at least one of the SSBs may hit the surface of the RIS 150. The RIS 150 may reflect the SSB via a number of different reflected beams in accordance with the configurations of the sub-RISs and, in some scenarios, at least one of the reflected beams may reach the UE 115.

The described techniques provide for incorporating active antenna panels in RIS 150 to enable a control unit associated with the RIS 150 to perform multi-array beam acquisition techniques for the surface of the RIS 150 and, based on the multi-array beam acquisition techniques, to configure the RIS 150 (e.g., configure a beam of the RIS 150 towards a network entity 105 or UE 115). In some cases, the control unit may be configured with active antenna panels. A first active antenna panel may be used for a first level of beam acquisition (e.g., wide beam acquisition), while a second active antenna panel may be used for a second level of beam acquisition (e.g., narrow beam acquisition).

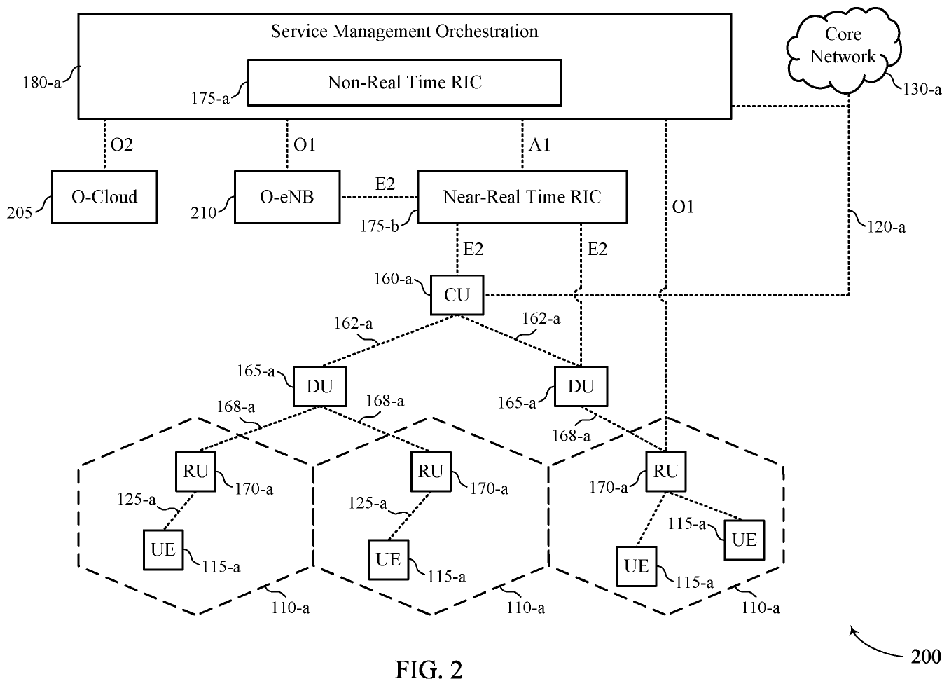

FIG. 2 illustrates an example of a network architecture 900 (e.g., a disaggregated base station architecture, a disaggregated RAN architecture) that supports multi-array design for binary beam acquisition of reconfigurable intelligent surfaces in accordance with one or more aspects of the present disclosure. The network architecture 200 may illustrate an example for implementing one or more aspects of the wireless communications system 100. The network architecture 200 may include one or more CUs 160-a that may communicate directly with a core network 130-a via a backhaul communication link 120-a, or indirectly with the core network 130-a through one or more disaggregated network entities 105 (e.g., a Near-RT RIC 175-b via an E2 link, or a Non-RT RIC 175-a associated with an SMO 180-a (e.g., an SMO Framework), or both). A CU 160-a may communicate with one or more DUs 165-a via respective midhaul communication links 162-a (e.g., an F1 interface). The DUs 165-a may communicate with one or more RUs 170-a via respective fronthaul communication links 168-a. The RUs 170-a may communicate with respective UEs 115-a via one or more communication links 125-a. In some implementations, a UE 115-a may be simultaneously served by multiple RUs 170-a.

Each of the network entities 105 of the network architecture 200 (e.g., CUs 160-a, DUs 165-a, RUs 170-a, Non-RT RICs 175-a, Near-RT RICs 175-b, SMOs 180-a, Open Clouds (O-Clouds) 205, Open eNBs (O-eNBs) 210) may include one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, over a wireless transmission medium to one or more of the other network entities 105.

In some examples, a CU 160-a may host one or more higher layer control functions. Such control functions may include RRC, PDCP, SDAP, or the like. Each control function may be implemented with an interface configured to communicate signals with other control functions hosted by the CU 160-a. A CU 160-a may be configured to handle user plane functionality (e.g., CU-UP), control plane functionality (e.g., CU-CP), or a combination thereof. In some examples, a CU 160-a may be logically split into one or more CU-UP units and one or more CU-CP units. A CU-UP unit may communicate bidirectionally with the CU-CP unit via an interface, such as an E1 interface when implemented in an O-RAN configuration. A CU 160-a may be implemented to communicate with a DU 165-a, as necessary, for network control and signaling.

A DU 165-a may correspond to a logical unit that includes one or more functions (e.g., base station functions, RAN functions) to control the operation of one or more RUs 170-a. In some examples, a DU 165-a may host, at least partially, one or more of an RLC layer, a MAC layer, and one or more aspects of a PHY layer (e.g., a high PHY layer, such as modules for FEC encoding and decoding, scrambling, modulation and demodulation, or the like) depending, at least in part, on a functional split, such as those defined by the 3rd Generation Partnership Project (3GPP). In some examples, a DU 165-a may further host one or more low PHY layers. Each layer may be implemented with an interface configured to communicate signals with other layers hosted by the DU 165-a, or with control functions hosted by a CU 160-a.

In some examples, lower-layer functionality may be implemented by one or more RUs 170-a. For example, an RU 170-a, controlled by a DU 165-a, may correspond to a logical node that hosts RF processing functions, or low-PHY layer functions (e.g., performing fast Fourier transform (FFT), inverse FFT (iFFT), digital beamforming, physical random access channel (PRACH) extraction and filtering, or the like), or both, based at least in part on the functional split, such as a lower-layer functional split. In such an architecture, an RU 170-a may be implemented to handle over the air (OTA) communication with one or more UEs 115-a. In some implementations, real-time and non-real-time aspects of control and user plane communication with the RU(s) 170-a may be controlled by the corresponding DU 165-a. In some examples, such a configuration may enable a DU 165-a and a CU 160-a to be implemented in a cloud-based RAN architecture, such as a vRAN architecture.

The SMO 180-a may be configured to support RAN deployment and provisioning of non-virtualized and virtualized network entities 105. For non-virtualized network entities 105, the SMO 180-a may be configured to support the deployment of dedicated physical resources for RAN coverage requirements which may be managed via an operations and maintenance interface (e.g., an O1 interface). For virtualized network entities 105, the SMO 180-a may be configured to interact with a cloud computing platform (e.g., an O-Cloud 205) to perform network entity life cycle management (e.g., to instantiate virtualized network entities 105) via a cloud computing platform interface (e.g., an O2 interface). Such virtualized network entities 105 can include, but are not limited to, CUs 160-a, DUs 165-a, RUs 170-a, and Near-RT RICs 175-b. In some implementations, the SMO 180-a may communicate with components configured in accordance with a 4G RAN (e.g., via an O1 interface). Additionally, or alternatively, in some implementations, the SMO 180-a may communicate directly with one or more RUs 170-a via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, Artificial Intelligence (AI) or Machine Learning (ML) workflows including model training and updates, or policy-based guidance of applications/features in the Near-RT RIC 175-b. The Non-RT RIC 175-a may be coupled to or communicate with (e.g., via an A1 interface) the Near-RT RIC 175-b. The Near-RT RIC 175-b may be configured to include a logical function that enables near-real-time control and optimization of RAN elements and resources via data collection and actions over an interface (e.g. via an E2 interface) connecting one or more CUs 160-a, one or more DUs 165-a, or both, as well as an O-eNB 210, with the Near-RT RIC 175-b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (e.g., reconfiguration via O1) or via generation of RAN management policies (e.g., A1 policies).

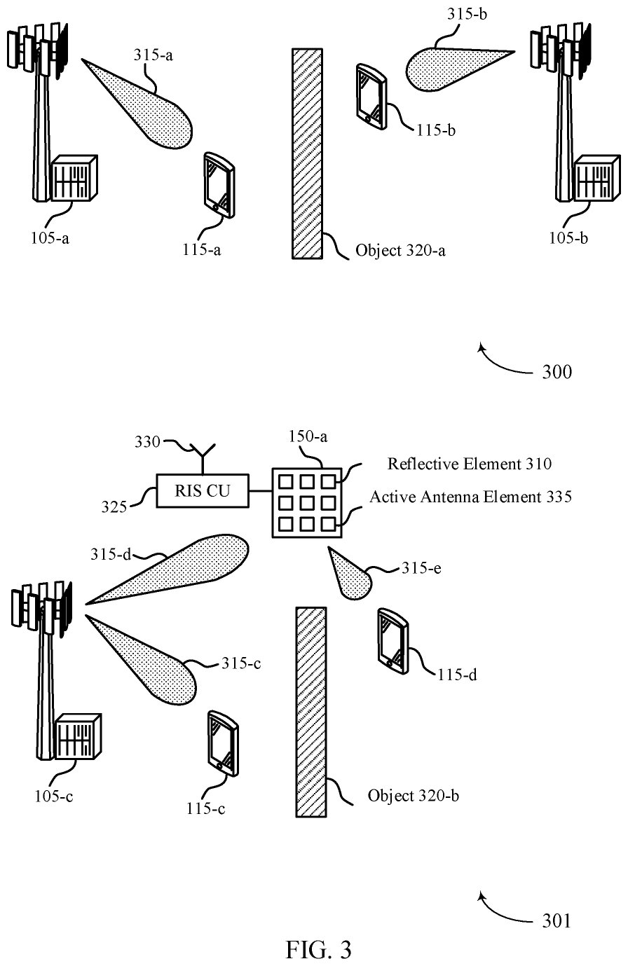

FIG. 3 illustrates an example of a wireless communications system 300 that supports multi-array design for binary beam acquisition of reconfigurable intelligent surfaces in accordance with one or more aspects of the present disclosure.

The wireless communications systems 300 and 301 may implement or be implemented to realize aspects of the wireless communications system 100. For example, the wireless communications systems 300 and 301 both illustrate communication between one or more UEs 115 and one or more network entities 105, which may be examples of corresponding devices described herein, including with reference to FIG. 1. In some implementations, a UE 115 and a network entity 105 may participate in an uplink signature procedure involving a reconfigurable intelligent surface (RIS) 150 in accordance with the examples disclosed herein.

Some systems may employ massive MIMO (such as 5G massive MIMO) to increase an achievable throughput between two communicating devices, and such systems may extend coverage via one or more active antenna units or one or more passive reflective surfaces (such as reconfigurable intelligent surfaces), or any combination thereof. For example, and as illustrated by the wireless communications system 300 in which a network entity 105-a transmits to a UE 115-a via a beam 315-a and a network entity 105-b transmits to a UE 115-b via a beam 315-b, some systems may achieve a relatively higher beamforming gain by using active antenna units. In some aspects, such active antenna units may be associated with a use of individual radio frequency chains per antenna ports. Such systems may experience a significant increase in power consumption due to the use of active antenna units.

For example, the wireless communications system 300 may include an object 320-a that blocks or otherwise inhibits a line-of-sight (LoS) link between the network entity 105-a and the UE 115-b. As such, the wireless communications system 300 may include the network entity 105-b, supporting an active antenna unit, to support wireless communications with the UE 115-b (as the network entity 105-a may be unable to support wireless communications with the UE 115-b due to a location of the object 320-a and a location of the UE 115-b). Thus, to support wireless communications with both the UE 115-a and the UE 115-b, the wireless communications system 300 may deploy two network entities 105 each operating separate active antenna units, which may be associated with an increase in power consumption. Further, although illustrated to show two network entities 105, the wireless communications system 300 may additionally or alternatively deploy one or more other devices capable of supporting an active antenna unit, such as a relay node or a smart repeater, to support wireless communications with both the UE 115-a and the UE 115-b.

Some systems (such as the wireless communications system 301) may, in addition or as an alternative to deploying additional active antenna units, employ the use of one or more assisting devices, such as one or more reconfigurable intelligent surfaces 150, to extend coverage (such as 5G coverage) with a negligible or relatively small increase in power consumption. In other words, some systems (e.g., including the wireless communications system 301) may leverage passive MIMO as a substitute for an active antenna unit. For example, the RIS 150-a may be a near-passive device capable of reflecting an impinging or incident wave to a desired location or in a desired direction.

As illustrated in the wireless communications system 301, for example, a network entity 105-c may use the RIS 150-a to reflect communications from the network entity 105-c via a beam 315-d(directed to the RIS 150-a) to a UE 115-d via a beam 315-e (directed from the RIS 150-a to the UE 115) to avoid an object 320-b. As such, the network entity 105-c (e.g., a single network entity 105 operating an active antenna unit) may communicate (directly) with a UE 115-c via a beam 315-c and may communicate (indirectly, due to a location of the object 320-b and the UE 115-d) with the UE 115-d via the RIS 150-a. A node or control unit, such as reconfigurable intelligent surface control unit (CU) 325, may configure a reflection characteristic of the RIS 150-a to control the reflection direction from the RIS 150-a and, in some aspects, a network entity 105 may configure or control the node or control unit (such that the network entity 105 may effectively configure or control the reflection direction of the RIS 150-a). In some examples, a network entity 105-c may transmit messaging to the CU 325 indicating a configuration of the RIS 150-a and the CU 325 may configure the RIS 150-a accordingly. In some aspects, a configuration of the RIS 150-a may be associated with a receive beam, such as a directional beam or configuration for directional “reception” of signaling, and a reflected beam, such a directional beam or configuration for directional reflection of the signaling. Further, although described herein as a “receive” beam, a receive beam associated with a configuration of the RIS 150-a may refer to reception as part of a reflecting (as opposed to, for example, as part of a decoding).

The RIS 150-a may function similarly to a mirror or other reflective surface in its ability to reflect incident beams or waves (such as light waves), but may differ in that the RIS 150-a may include one or more components that are able to control or dictate how an incident beam or wave is reflected (such that an angle of incidence can be different than an angle of reflection) or that are able to control or dictate a shape of a reflected beam or wave (such as via energy focusing or energy nulling via constructive interference or destructive interference, respectively), or both. For example, the RIS 150-a may include a quantity of reflective elements 310 that each have a controllable delay, phase, or polarization, or any combination thereof, and the CU 325 may control or configure each of the reflective elements 310 to control how an incident beam or wave is reflected or to control a shape of a reflected beam or wave. In some examples, the RIS 150-a may include a quantity of active antenna elements 335 that enables CU 325 to perform configure RIS 150-a based on beam acquisition techniques via the active antenna elements 335. In some cases, the active antenna elements 335 may provide CU 325 with transmission and reception capabilities.

The RIS 150-a may be an example of or may otherwise be referred to as a software-controlled metasurface, a configurable reflective surface, a reflective intelligent surface, or a configurable intelligent surface, and may sometimes be a metal surface (such as a copper surface) including a quantity of reflective elements 310. In some aspects, a CU 325 may be coupled with the RIS 150-a via hardware (such as via a fiber optic cable). In some other aspects, a CU 325 may be non-co-located with the RIS 150-a and may configure the RIS 150-a via over-the-air signaling.

In some examples, the CU 325 may have both transmission and reception capability via one or more antennas 330. The CU 335 may use its transmission and reception capability to assist in establishing an radio resource control (RRC) connection between the network entity 105-c and the CU 335. For example, the network entity 105-c may sweep over a set of synchronization signal block (SSB) beams and the CU 335 may measure each of the set of SSB beams and respond with a RACH preamble corresponding to a strongest of the set of SSB beams. In some cases, the CU 335 may use the transmission and reception capabilities of the active antenna elements 335 to assist in establishing an RRC connection between the network entity 105-c and the CU 335. As such, the network entity 105-c may learn (based on receiving a random access channel preamble response from the CU 335) which beam to use to communicate with the CU 335. The network entity 105-c may use the same beam to transmit signaling to the RIS 150-a (such as to “light up” a surface of the RIS 150-a), which may support or otherwise facilitate a configuration of the RIS 150-a, by the network entity 105-c, such that a receive beam of the RIS 150-a is oriented toward the network entity 105-c.

In some examples, RIS 150-a may include a first antenna panel and a second antenna panel. The first antenna panel or the second antenna panel may include multiple active antenna elements (e.g., active antenna element 335). In some cases, first antenna panel may include active antenna element 335 or the second antenna panel may include active antenna element 335, or both may include active antenna element 335 (e.g., shared or overlapping active antenna elements). In some cases, CU 335 may receive from network entity 105-c multiple reference signals (e.g., channel state information reference signals) via multiple receive beams. CU 335 may acquire a first beam of the multiple receive beams via the first antenna panel, and acquire a second beam of the multiple receive beams via the second antenna panel. In some cases, CU 335 may analyze the acquired beams and generate a configuration for RIS 150-a based on the analysis. In some cases, the configuration for RIS 150-a may include reflection coefficients of RIS 150-a configured for communication between the RIS 150-a and the network entity 105-c based on the acquiring of the first beam and the acquiring of the second beam. Accordingly, communication via the RIS 150-a may be based on the reflection coefficients of the RIS 150-a.

In some examples, network entity 105-c may receive multiple reference signals (e.g., sounding reference signals) transmitted from CU 335 via multiple beams (e.g., a set of beams via a first panel of CU 325 and a set of beams via a second panel of CU 325). In some cases, network entity 105-c may select a first beam of the multiple beams from the first antenna panel and select a second beam of the multiple beams from the second antenna panel. In some cases, network entity 105-c may determine a configuration for RIS 150-a based on the selected first beam and the selected second beam. The network entity 105-c may signal the configuration of the RIS 150-a to CU 325. The CU 325 may then configure the RIS 150-a based on the signaled configuration.

The techniques described herein may improve power usage and free up processing cycles of one or more devices (e.g., battery-operated devices, a UE 115 of FIG. 1) based on improved aspects of communication (e.g., increased signal quality, increased throughput, increased transmission efficiency, increased power savings) between UE 115-d, RIS 150-a, and network entity 105-c. Additionally, described techniques may result in avoiding multiple retransmissions and failed transmissions, decreasing system latency, improving the reliability of transmissions between the UE 115-d and the network entity 105-c via the RIS 150-a, and improving user experience.

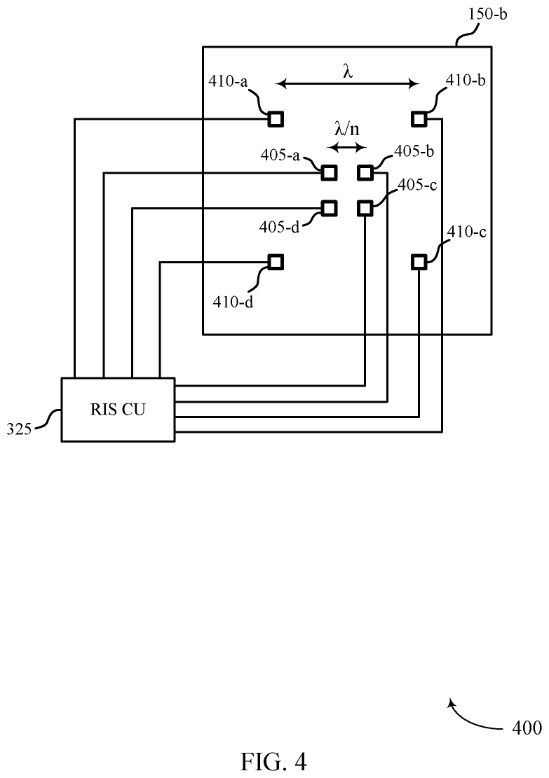

FIG. 4 illustrates an example of a wireless communications system 400 that supports multi-array design for binary beam acquisition of reconfigurable intelligent surfaces in accordance with one or more aspects of the present disclosure. In some examples, some aspects of wireless communications system 400 may implement or be implemented by aspects of wireless communications system 100. For example, wireless communications system 400 may include CU 425 and RIS 150-b, which may be examples of a RIS 150 or CU 425 described with reference to FIGS. 1 and 2.

In the illustrated example, RIS 150-b may include one or more reflective elements, as well as one or more active antenna elements. As shown, RIS 150-b may include antenna elements 405 (e.g., antenna element 405-a, antenna element 405-b, antenna element 405-c, and antenna element 405-d) and antenna elements 410 (e.g., antenna element 410-a, antenna element 410-b, antenna element 410-c, and antenna element 410-d). As shown, antenna elements 405 and antenna elements 410 may connect to CU 325.

In the illustrated example, a first antenna panel may include antenna elements 405 and a second antenna panel may include antenna elements 410, where an inter-element spacing of the first antenna panel is smaller or narrower than an inter-element spacing of the second antenna panel. In the illustrated example, the first antenna panel of antenna elements 405 may have an inter-element spacing of λ/n, while the second antenna panel of antenna elements 410 may have an inter-element spacing of λ. In some cases, the first antenna panel of antenna elements 405 may be referred to as a narrow antenna panel based on the relatively narrow inter-element spacing of antenna elements 405. In some cases, the second antenna panel of antenna elements 410 may be referred to as a wide antenna panel based on the relatively wide inter-element spacing of antenna elements 410.

In some examples, CU 325 may receive from a network entity multiple reference signals via multiple receive beams. The multiple receive beams may be received via the first antenna and the second antenna panel. In some cases, CU 325 may acquire, via the first antenna panel, a first beam of the multiple receive beams, and acquire, via the second antenna panel, a second beam of the multiple receive beams. The CU 325 may determine reflection coefficients of the RIS 150-b based on the acquiring of the first beam and the acquiring of the second beam. The CU 325 may configure the RIS 150-b based on the determined reflection coefficients, where the determined reflection coefficients may be used for communication between RIS 150-b and the network entity.

In some examples, CU 325 may transmit multiple reference signals to a network entity via the first antenna panel and the second antenna panel. In some cases, the network entity may select a first beam of the multiple beams for the first antenna panel, and select a second beam of the multiple beams for the second antenna panel. The network entity may determine a configuration for RIS 150-b based on the selected first beam and the selected second beam. The network entity may then signal a configuration of the RIS 150-b to the CU 325, and CU 325 may configure the RIS 150-b based on the received configuration.

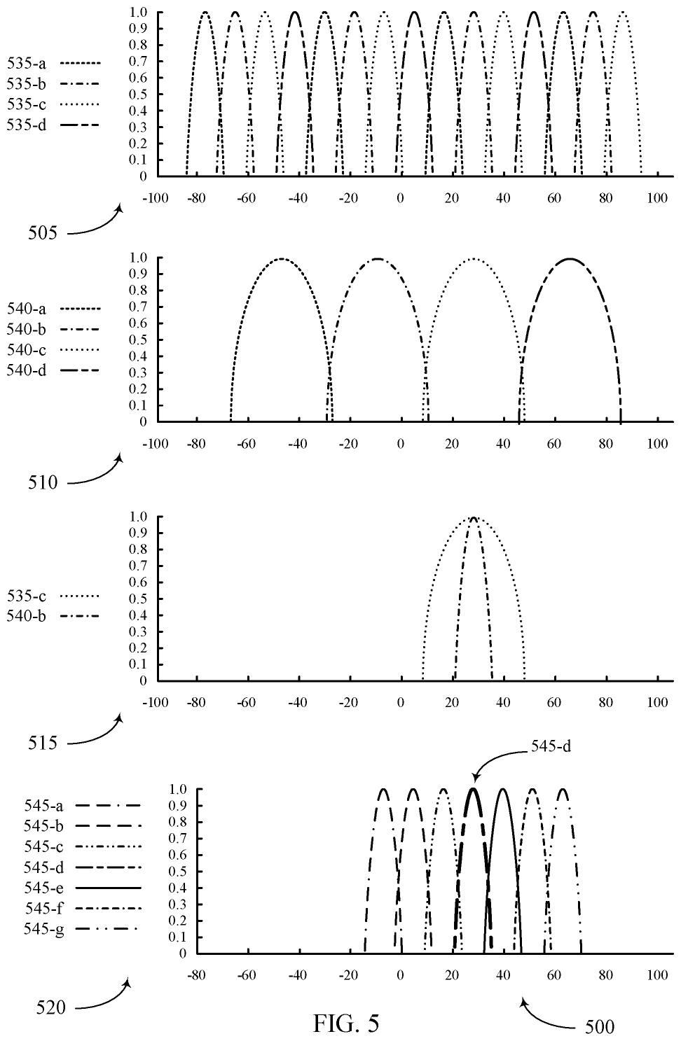

FIG. 5 illustrates an example of beam graphs 500 that support multi-array design for binary beam acquisition of reconfigurable intelligent surfaces in accordance with one or more aspects of the present disclosure. In some examples, some aspects of beam graphs 500 may implement or be implemented by aspects of wireless communications system 100. For example, beam graphs 500 may include wide panel beam measurements 505, narrow panel beam measurements 510, superposed beam measurements 515, and reconfigurable intelligent surface (RIS) beams 520, which may be associated with or measured by a network entity 105, a UE 115, CU 325, or RIS 150 described with reference to FIGS. 1, 2, and 3.

In the illustrated example, the wide panel beam measurements 505 may include first wide panel beam 535-a, second wide panel beam 535-b, third wide panel beam 535-c, and fourth wide panel beam 535-d. The narrow panel beam measurements 510 may include first narrow panel beam 540-a, second narrow panel beam 540-b, third narrow panel beam 540-c, and fourth narrow panel beam 540-d. In some cases, the wide panel beam measurements 505 may be based on beams associated with a wide antenna panel of a CU 325 (e.g., with inter-element spacing of λ), while the narrow panel beam measurements 510 may be based on beams associated with a narrow antenna panel of the CU 325 (e.g., with inter-element spacing of λ/2). In some cases, the narrow panel may be used for communications between CU 325 and the network entity 105.

In some examples, the wide panel beam measurements 505 may be based on multiple reference signals transmitted by a network entity 105 in multiple beams and received by the wide antenna panel of the CU 325. In some cases, the narrow panel beam measurements 505 may be based on the multiple reference signals transmitted by the network entity 105 in multiple beams and received by the narrow antenna panel of the CU 325.

In some examples, the network entity 105 may perform beam measurements. In some cases, wide panel beam measurements at the network entity 105 may be based on multiple reference signals transmitted by the wide antenna panel of the CU 325 in multiple beams and received by the network entity 105. In some cases, narrow panel beam measurements at the network entity 105 may be based on multiple reference signals transmitted by the narrow antenna panel of the CU 325 in multiple beams and received by the network entity 105.

In some examples, the CU 325 may acquire, of the multiple beams, one beam per active antenna panel (e.g., one beam for the narrow antenna panel, one beam for the wide antenna panel). In the illustrated example, the CU 325 may acquire third wide panel beam 535-c via the wide panel and acquire second narrow panel beam 540-b via the narrow panel.

In some examples, the CU 325 may superpose one acquired beam in relation to the other acquired beam. As shown, the superposed beam measurements 515 depicts the CU 325 superposing third wide panel beam 535-c in relation to second narrow panel beam 540-b.

In the illustrated example, RIS beams 520 may depict beams incident upon and reflecting off of a RIS 150. As shown, the RIS beams 520 may include first RIS beam 545-a, second RIS beam 545-b, third RIS beam 545-c, fourth RIS beam 545-d, fifth RIS beam 545-e, sixth RIS beam 545-f, and seventh RIS beam 545-g. The RIS beams 520 may depict beams from a network entity 105 incident upon and reflected by the RIS 150 towards a UE 115. In some cases, the RIS beams 520 may depict beams from the UE 115 incident upon and reflected by the RIS 150 to the network entity 105.

In some examples, the CU 325 may identify a beam of RIS beams 520 based on the superposition of third wide panel beam 535-c and second narrow panel beam 540-b. In some cases, CU 325 may determine that fourth RIS beam 545-d corresponds to the superposition of third wide panel beam 535-c and second narrow panel beam 540-b. Upon identifying fourth RIS beam 545-d as corresponding to the superposition of third wide panel beam 535-c and second narrow panel beam 540-b, CU 325 may configure RIS 150 to use fourth RIS beam 545-d for communication between the RIS 150 and the network entity 105.

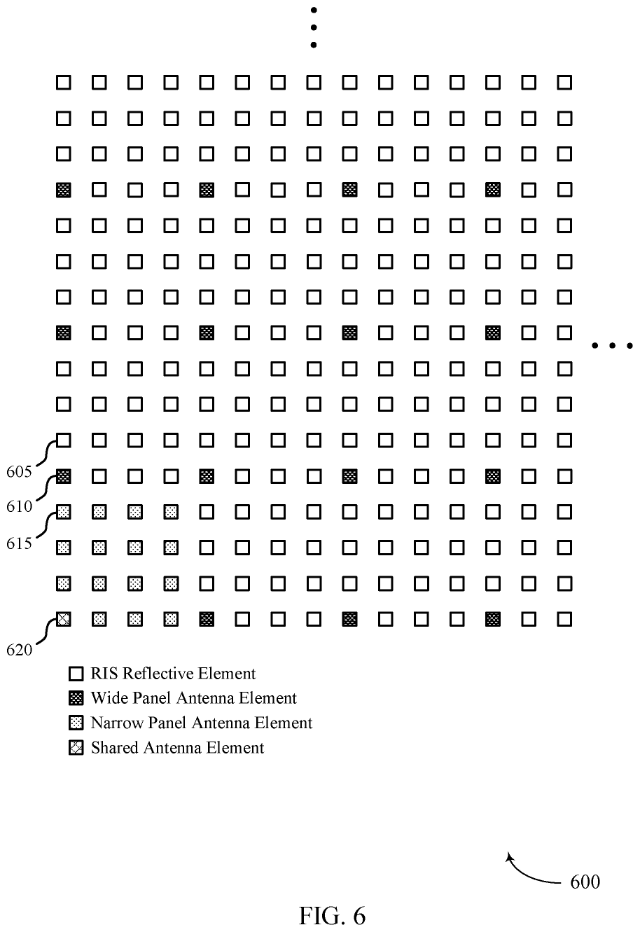

FIG. 6 illustrates an example of a reconfigurable intelligent surface 600 that supports multi-array design for binary beam acquisition of reconfigurable intelligent surfaces in accordance with one or more aspects of the present disclosure.

In some cases, RIS 600 may be an example of a RIS 150 of FIGS. 1-4. In some examples, some aspects of the RIS 600 may implement or be implemented by aspects of wireless communications system 100. For example, some aspects of the RIS 600 may be associated with or configured by a network entity 105, a UE 115, CU 325, or RIS 150 described with reference to FIGS. 1-4.

In the illustrated example, the RIS 600 may include RIS reflective elements 605, wide panel antenna elements 610, narrow panel antenna element 615, and shared antenna element 620. A wide panel of a CU 325 may include the wide panel antenna elements 610, while a narrow panel of the CU 325 may include the narrow panel antenna element 615. As shown, one or more elements of the wide panel may overlap with one or more elements of the narrow panel, as depicted by the shared antenna element 620. Although the active antenna panels (e.g., wide panel antenna elements 610, narrow panel antenna element 615, and shared antenna element 620) are depicted as being part of RIS 600, the active antenna panels are connected to the CU 325 (e.g., the active antenna panels are a part of CU 325, an extension of CU 325). In some cases, the active antenna panels may be located apart from a reconfigurable intelligent surface such as RIS 600.

When the narrow panel has inter-element spacing of λ/2, the wide panel may have inter-element spacing of Nλ/2, where N is the number of elements in the dimension in which inter-element spacing is measured. In the illustrated example, the narrow panel has four antenna elements in each direction with an inter-element spacing of λ/2. Thus, the depicted wide panel has 4 elements in each direction with an inter-element spacing of 4λ/2=2λ. For an 8×8 antenna panel, where x=8 and y=8, then N=x when inter-element spacing is measured in the x dimension, or N=y when inter-element spacing is measured in y dimension. Thus, the narrow panel may be an 8×8 antenna panel with inter-element spacing of λ/2 (e.g., in both horizontal and vertical dimensions), while the wide panel may be an 8×8 antenna panel with an inter-element spacing of Nλ/2, where N=8, thus an inter-element spacing of 4λ. This inter-element spacing configuration effectively provides a beam resolution of N² in each dimension. In the illustrated example, the RIS 600 may have as many as 64×64=4K elements. One of the 4K orthogonal beams may be selected by the narrow panel or wide panel based on 64 reference signal transmissions.

In some examples, the RIS 600 may have as many as N² RIS reflective elements 605, while the number of wide panel antenna elements 610 and narrow panel antenna element 615 is based on 2N−1. In the illustrated example, N=16, thus the RIS 600 has N²=16²=256 RIS reflective elements 605, while there are 15 wide panel antenna elements 610, 15 narrow panel antenna element 615, and 1 shared antenna element, for a total of 31 antenna elements, in accordance with 2N−1=2(16)−1=31 antenna elements. Thus, based on the 1 shared antenna element, there are 16 wide panel antenna elements 610 and 16 narrow panel antenna element 615. Accordingly, 16 reference signals may be used to train the RIS 600, or identify one or more beams of the RIS 600 to use for communication with a network entity 105. In some cases, the 16 reference signals may include 16 reference signals (e.g., 16 channel state information reference signals) transmitted by the network entity 105 and received at the narrow panel and the wide panel of the CU 325 and analyzed by the CU 325. In some cases, the 16 reference signals may include 16 reference signals (e.g., 16 sounding reference signals) transmitted by the narrow panel and 16 reference signals (e.g., 16 sounding reference signals) transmitted by the wide panel of the CU 325 that are received and analyzed at the network entity 105.

In the absence of channel reciprocity between a narrow panel and wide panel of a CU 325, the network entity 105 may indicate to the CU 325 what precoding matrix to use in configuring the RIS 600 for uplink transmission. In some cases, the network entity 105 may configure a UE 115 with a sounding reference signal (SRS) resource set with a usage codebook. In some cases, the determination of the codebook may depend on a capability report from the UE 115 (e.g., regarding a coherence of the antenna panels).

In some examples, the UE 115 may transmit non-precoded SRS towards the network entity (e.g., via reflection off of the RIS 600 or via the wide panel and narrow panel of CU 325), and the network entity 105 may determine a first transmit precoding matrix index (TPMI) associated with the narrow panel, a second TPMI associated with the wide panel, and transmit the first TPMI and the second TPMI to the CU 325, where the CU 325 determines a TPMI for the RIS 600 based on mappings that map a set of first TPMI and second TPMI to a TPMI for the RIS 600. In some cases, the network entity 105 may signal the mappings to the CU 325 via a configuration message (e.g., downlink control information, media access control-control element, radio resource control). In some cases, the network entity 105 may determine a TPMI for the RIS 600 based on the mappings, and transmit the mapped TPMI of the RIS 600 to the CU 325.

In some examples, the CU 325 may provide information to the network entity 105 regarding the configuration of the narrow panel and the wide panel (e.g., inter-element spacing of each panel, number of antenna elements for each panel). In some cases, the configuration information may include a configuration of RIS 600 (e.g., inter-element spacing of reflective elements, number of reflective elements). In some cases, the network entity 105 may determine the TPMI for the RIS 600 based on the configuration information and signal the TPMI for the RIS 600 to the CU 325, and the CU 325 may configure the RIS 600 based on the received TPMI.

In some examples, TPMI derivation for the surface of RIS 600 may be based on a determination or an assumption of an inter-element spacing for the wide panel (e.g., inter-element spacing of Nλ/2). A configuration based on this determination or assumption may support N² beams at the surface of RIS 600. In some cases, the selected transmit precoding matrix for the narrow panel of CU 325 (0≤k<N) may be based on the following:

$$[ \begin{matrix}{e}^{- j \frac{0 \cdot k π}{N}} \\ {e}^{- j \frac{1 \cdot k π}{N}} \\ {e}^{- j \frac{2 \cdot k π}{N}} \\ … \\ {e}^{- j \frac{( N - 1 ) \cdot k π}{N}}\end{matrix} ]$$

In some cases, the selected transmit precoding matrix for the wide panel of CU 325 (0≤ [symbol] <N) may be based on the following:

$$[ \begin{matrix}{e}^{- j \frac{0 \cdot ℓ π}{N}} \\ {e}^{- j \frac{1 \cdot ℓ π}{N}} \\ {e}^{- j \frac{2 \cdot ℓ π}{N}} \\ … \\ {e}^{- j \frac{( N - 1 ) \cdot ℓπ}{N}}\end{matrix} ]$$

Based on the selected transmit precoding matrix for the narrow panel and the selected transmit precoding matrix for the wide panel above and the inter-element spacing of Nλ/2, the network entity 105 or the CU 325 may derive the transmit precoding matrix for surface of RIS 600 as follows:

$$[ \begin{matrix}{e}^{- j \frac{0 \cdot s π}{{N}^{2}}} \\ {e}^{- j \frac{1 \cdot s π}{{N}^{2}}} \\ {e}^{- j \frac{2 \cdot s π}{{N}^{2}}} \\ … \\ {e}^{- j \frac{( {N}^{2} - 1 ) \cdot s π}{{N}^{2}}}\end{matrix} ]$$

where s=mod(kN+mod( [symbol] +c,N)−c,N²), and c is a constant which can be

$$c ∈ \{ ⌊ \frac{N}{2} ⌋ - 1 , ⌊ \frac{N}{2} ⌋ , ⌊ \frac{N}{2} ⌋ + 1 \} .$$

In some examples, TPMI derivation for the surface of RIS 600 may be based on a determination or an assumption of an inter-element spacing for the wide panel (e.g., inter-element spacing of Mλ/2 for some M<N). A configuration based on this determination or assumption may support up to MN beams at the surface of RIS 600.

Based on the selected transmit precoding matrix for the narrow panel and the selected transmit precoding matrix for the wide panel above and the inter-element spacing of Mλ/2, the network entity 105 or the CU 325 may derive the transmit precoding matrix for surface of RIS 600 as follows:

$$[ \begin{matrix}{e}^{- j \frac{0 \cdot s π}{MN}} \\ {e}^{- j \frac{1 \cdot s π}{MN}} \\ {e}^{- j \frac{2 \cdot s π}{MN}} \\ … \\ {e}^{- j \frac{( {N}^{2} - 1 ) \cdot s π}{MN}}\end{matrix} ]$$

$$where s = arg {min}_{p ∈ L} {min}_{t ∈ K} \vert t - p \vert , L = mod ( \{ ℓ , ℓ + N , … , ℓ + ( M - 1 ) N \} , NM ) , and K = mod ( \{ kM - ⌊ \frac{M}{2} ⌋ , … , kM + ⌊ \frac{M}{2} ⌋ \} , NM ) .$$

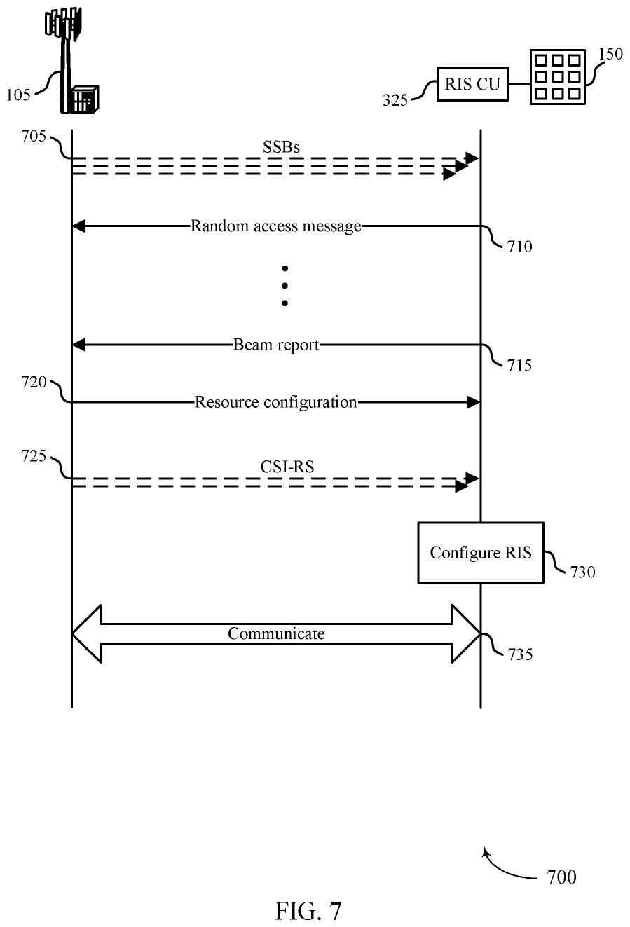

FIG. 7 illustrates an example of a process flow 700 that supports multi-array design for binary beam acquisition of reconfigurable intelligent surfaces in accordance with one or more aspects of the present disclosure. In some examples, some aspects of process flow 700 may implement or be implemented by aspects of wireless communications system 100. For example, process flow 700 may include a network entity 105, CU 325, and RIS 150, which may be examples of a network entity 105, CU 325, or RIS 150 described with reference to FIGS. 1-5.

At 705, network entity 105 may transmit multiple synchronization signal blocks to CU 325. In some cases, the CU 325 may use a wide receive beam to establish a connection (e.g., radio resource control connection) with the network entity 105.

At 710, CU 325 may transmit a random access message to the network entity 105. The random access message may include a random access preamble.

At 715, CU 325 may transmit a beam report to the network entity 105. In some cases, the beam report may indicate whether a beam correspondence is true.

At 720, the network entity 105 may transmit control information (e.g., resource configuration) to CU 325. In the presence of beam correspondence (e.g., beam correspondence=true), the network entity 105 may configure repeated reference signals for transmission towards the antenna panels (e.g., wide panel and narrow panel) of CU 325. In some cases, control information for the reference signals may indicate that repetition is on and that reporting is off (e.g., reportQuantity=none).

At 725, the network entity 105 may transmit multiple reference signals (e.g., multiple channel state information reference signals) to the antenna panels of CU 325. In some cases, CU 325 may simultaneously sweep the reference signal beams on each of the antenna panels (e.g., wide panel and narrow panel). In some cases, the CU 325 may perform channel state measurements for each reference signal on each antenna panel. The channel state measurements may include reference signal received power (RSRP), channel quality indicator (CQI), precoding matrix indicator (PMI), CSI-RS resource indicator (CRI), strongest layer indicator (SLI), rank indicator (RI), layer-1 RSRP (L1-RSRP), or CRI-RSRP measurements, or any combination thereof.

At 730, the CU 325 may configure the RIS 150 based on an analysis of the channel state measurements. In some cases, the CU 325 may select one beam for each antenna panel (e.g., select a first beam based on a best beam for the narrow panel, select a second beam based on a best beam for the wide panel). In some cases, the CU 325 may configure the RIS 150 with a relatively narrow beam towards the network entity 105 based on each of the selected beams. In some cases, the CU 325 may determine a correspondence between the beam of the RIS 150 (e.g., the relatively narrow beam) and a superposition of the first beam for the narrow panel and the second beam for the wide panel.

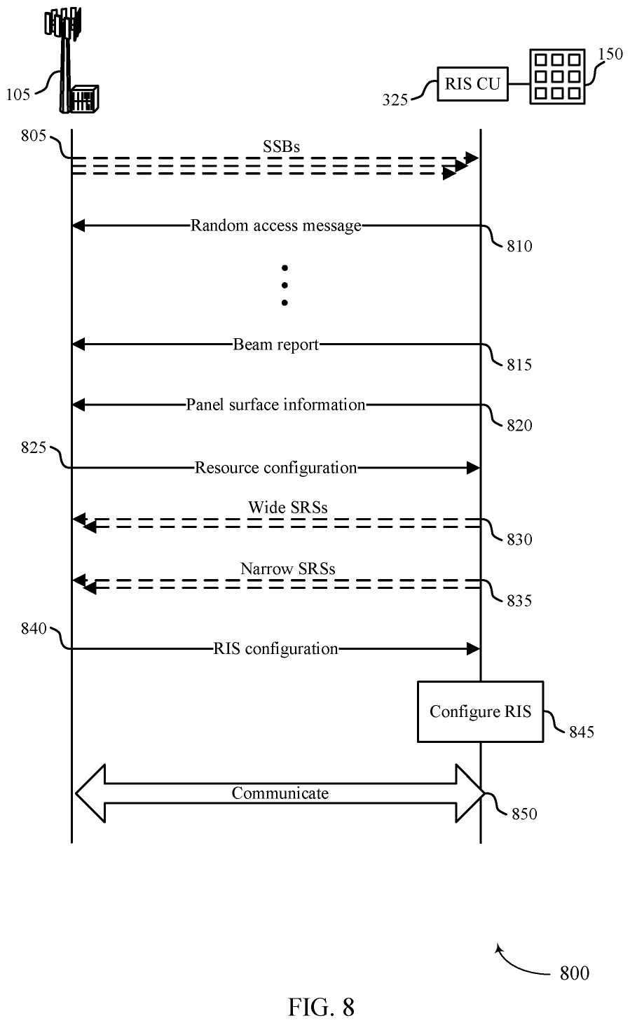

FIG. 8 illustrates an example of a process flow 800 that supports multi-array design for binary beam acquisition of reconfigurable intelligent surfaces in accordance with one or more aspects of the present disclosure. In some examples, some aspects of process flow 800 may implement or be implemented by aspects of wireless communications system 100. For example, process flow 800 may include a network entity 105, CU 325, and RIS 150, which may be examples of a network entity 105, CU 325, or RIS 150 described with reference to FIGS. 1-6.

At 805, network entity 105 may transmit multiple synchronization signal blocks to CU 325. In some cases, the CU 325 may use a wide receive beam to establish a connection (e.g., radio resource control connection) with the network entity 105.

At 810, CU 325 may transmit a random access message to the network entity 105. The random access message may include a random access preamble.

At 815, CU 325 may transmit a beam report to the network entity 105. In some cases, the beam report may indicate whether a beam correspondence is false.

At 820, CU 325 may transmit panel surface information to the entity 105 (e.g., based on beam correspondence=false). In some cases, the panel surface information may include a configuration of antenna panels (e.g., inter-element spacing of antenna elements, number of antenna elements of narrow panel and wide panel) associated with CU 325. In some cases, the panel surface information may include a configuration of RIS 150 (e.g., inter-element spacing of reflective elements, number of reflective elements).

At 825, the network entity 105 may transmit control information (e.g., resource configuration) to CU 325. In the presence of beam correspondence (e.g., beam correspondence=false), the network entity 105 may configure repeated reference signals for transmission to the network entity 105 from the antenna panels of CU 325 (e.g., wide panel and narrow panel). In some cases, control information for the reference signals may indicate that usage is for beam management (e.g., usage=beamManagement). In some cases, the resource configuration may include one resource set per antenna panel of CU 325.

At 830, a wide panel of CU 325 may transmit multiple reference signals to network entity 105. In some cases, the multiple reference signals may include multiple sounding reference signals. In some cases, CU 325 may sweep transmission of the reference signal beams on each antenna element of the wide panel.

At 835, a narrow panel of CU 325 may transmit multiple reference signals to network entity 105. In some cases, the multiple reference signals may include multiple sounding reference signals. In some cases, CU 325 may sweep transmission of the reference signal beams on each antenna element of the narrow panel.

At 840, the network entity 105 may transmit a configuration for RIS 150 based on the multiple reference signals transmitted at 830 and 835. In some cases, the configuration may include spatial relationship information (e.g., spatialRelationInfo command) relative to the narrow panel, the wide panel, and the reflective elements of the RIS 150. In some cases, the network entity 105 may analyze the multiple reference signals and determine a strongest beam for each SRS resource set (e.g., strongest wide panel beam and strongest narrow panel beam). Using the reported inter-element spacing for each antenna panel, the network entity 105 may configure the RIS beam for the surface of RIS 150.

At 845, the CU 325 may configure the RIS 150 based on the configuration CU 325 receives from the network entity 105. In some cases, CU 325 may configure the RIS 150 based on the spatial relationship information that correlates the configuration of the narrow panel and the wide panel, the configuration of the RIS 150, and the multiple reference signals transmitted to the network entity 105.

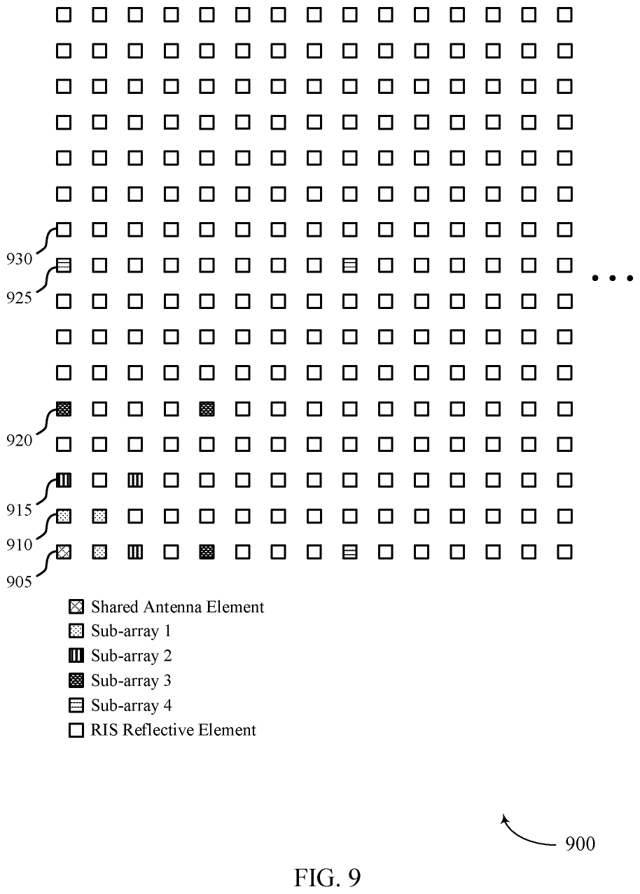

FIG. 9 illustrates an example of a reconfigurable intelligent surface 900 that supports multi-array design for binary beam acquisition of reconfigurable intelligent surfaces in accordance with one or more aspects of the present disclosure. In some cases, RIS 900 may be an example of a RIS 150 of FIGS. 1-7. In some examples, some aspects of the RIS 900 may implement or be implemented by aspects of wireless communications system 100. For example, some aspects of the RIS 900 may be associated with or configured by a network entity 105, a UE 115, CU 325, or RIS 150 described with reference to FIGS. 1-4.

In the illustrated example, the RIS 900 may include shared antenna elements 905, first sub-array elements 910, second sub-array elements 915, third sub-array elements 920, fourth sub-array elements 925, and RIS reflective elements 930.

In some examples, the described techniques may use K sub-arrays (e.g., first sub-array elements 910, second sub-array elements 915, third sub-array elements 920, fourth sub-array elements 925) in relation to RIS 900, where each sub-array includes two antenna elements in a given dimension. In some cases, the spacing between the two elements for subarray k∈{1, . . . , K} is 2^{k-2} λ. This allows the described techniques to support up to 2^{K} beams at the RIS 900 in a given dimension.

In some examples, the RIS 900 may be configured with log N sub-arrays, where each sub-array includes two elements in each direction. In some cases, antenna elements between sub-arrays may be shared (e.g., shared antenna elements 905).

In some examples, the configuration of RIS 900 may be based on the number of reflective elements of RIS 900 being based on N squared (e.g., numRISelements=N²). In some cases, the number of antenna elements of the sub-arrays is based on a logarithmic algorithm (e.g., numAntennas=3log₂N+1). In the illustrated example, with N=16, numAntennas=3log₂N+1=3log₂(16)+1=13 antenna elements, and numRISelements=N²=(16)²=256 reflective elements. Thus, the configuration of RIS 900 may include 13 antenna elements (e.g., all antenna elements of the depicted sub-arrays) enabling a CU 325 to train 256 reflective elements of RIS 900 (e.g., identifying one or more beams of the RIS 900 to use for communication with a network entity 105).

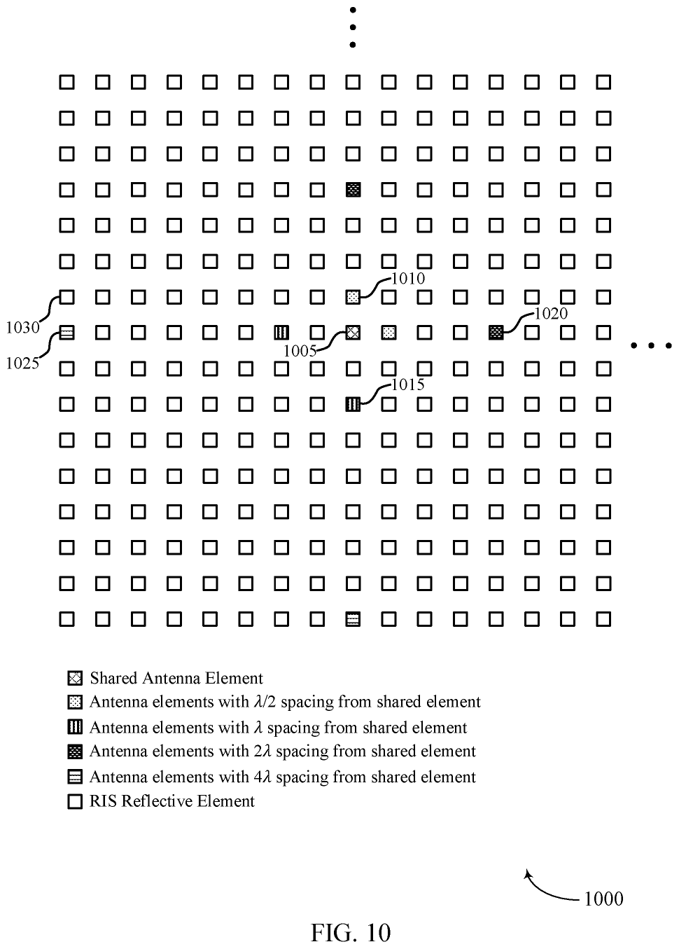

FIG. 10 illustrates an example of a reconfigurable intelligent surface 1000 that supports multi-array design for binary beam acquisition of reconfigurable intelligent surfaces in accordance with one or more aspects of the present disclosure. In some cases, RIS 1000 may be an example of a RIS 150 of FIGS. 1-7. In some examples, some aspects of the RIS 1000 may implement or be implemented by aspects of wireless communications system 100. For example, some aspects of the RIS 1000 may be associated with or configured by a network entity 105, a UE 115, CU 325, or RIS 150 described with reference to FIGS. 1-4.

In the illustrated example, the RIS 1000 may include shared antenna element 1005, first sub-array elements 1010 (with λ/2 inter-element spacing), second sub-array elements 1015 (with λ inter-element spacing), third sub-array elements 1020 (with 2λ inter-element spacing), fourth sub-array elements 1025 (with 4λ inter-element spacing), and RIS reflective elements 1030.

In some examples, the configuration of RIS 1000 may be based on the number of reflective elements of RIS 1000 being based on N squared (e.g., numRISelements=N²). In some cases, the number of antenna elements of the sub-arrays is based on a logarithmic algorithm (e.g., numAntennas=2log₂N+1). In the illustrated example, with N=16, numAntennas=2log₂N+1=2log₂(16)+1=9 antenna elements, and numRISelements=N²=(16)²=256 reflective elements. Thus, the configuration of RIS 1000 may include 9 antenna elements (e.g., all antenna elements of the depicted sub-arrays) enabling a CU 325 to train 256 reflective elements of RIS 1000 (e.g., identifying one or more beams of the RIS 1000 to use for communication with a network entity 105).

In some examples, two beams may be associated with the first sub-array elements 1010 (with λ/2 inter-element spacing), two beams may be associated with the second sub-array elements 1015 (with λ inter-element spacing), two beams may be associated with the third sub-array elements 1020 (with 2λ inter-element spacing), and two beams may be associated with the fourth sub-array elements 1025 (with 4λ inter-element spacing), where the CU 325 may select one beam for each sub-array. In some cases, the CU 325 may superpose each of the selected beams of each sub-array, identify a convergence of the superposed selected beams, and thus select a beam for the RIS 1000 based on the superposition of the selected beams.

In some examples, based on sub-array k∈{1, . . . , K} with inter-element spacing 2^{k-2}λ, a CU 325 may select beam bₖ∈{0,1}. Considering the binary number b₁b₂ . . . b_{K} which is equal to C=b_{K}+2b_{K-1}+4b_{K-2}+ . . . +2^{K-1}b₁, the selected beam for the RIS 1000 may be a function of this number. For instance, the selected beam may be based on C or it may be based on mod (C−2^{K-1})+2^{K-1}.

In some examples, the configuration of RIS 1000 may be based on capability signaling of CU 325 to network entity 105 regarding the number of sub-arrays, inter-element spacing, antenna panel configuration, RIS configuration, etc. In some cases, the CU 325 may communicate to the network entity 105 which of the set of standard configurations CU 325 deploys.

In some examples, the derivation of the RIS beam for RIS 1000 may be based on the selected beam for each sub-array. For instance, based SRS transmitted from each sub-array, network entity 105 may signal the selected beam or TPMI for each subarray to the CU 325. The CU 325 may apply a configuration or specification to map these TPMI or beams to the TPMI or beam for RIS 1000.

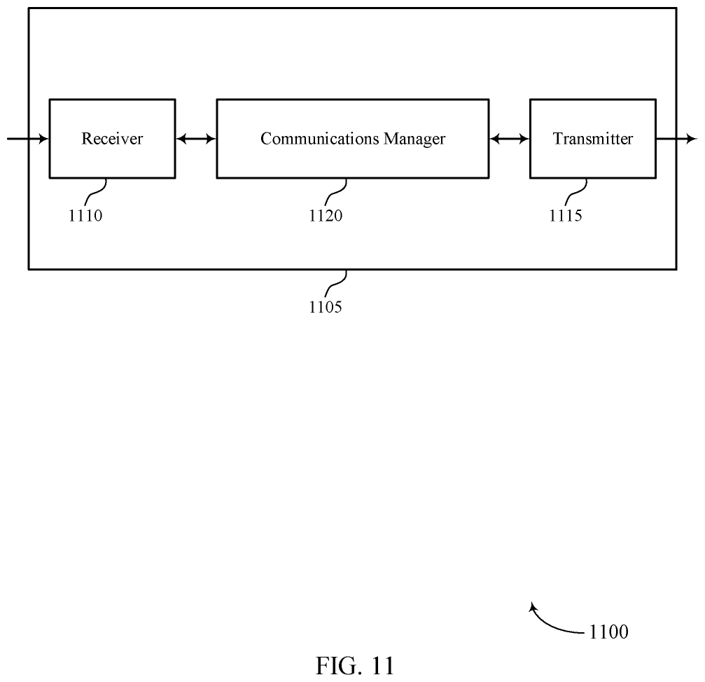

FIG. 11 shows a block diagram 1100 of a device 1105 that supports multi-array design for binary beam acquisition of reconfigurable intelligent surfaces in accordance with one or more aspects of the present disclosure. The device 1105 may be an example of aspects of a control unit as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for receiving information such as packets, user data, control information, or any combination thereof associated with various information channels (e.g., control channels, data channels, information channels related to multi-array design for binary beam acquisition of reconfigurable intelligent surfaces). Information may be passed on to other components of the device 1105. The receiver 1110 may utilize a single antenna or a set of multiple antennas.

The transmitter 1115 may provide a means for transmitting signals generated by other components of the device 1105. For example, the transmitter 1115 may transmit information such as packets, user data, control information, or any combination thereof associated with various information channels (e.g., control channels, data channels, information channels related to multi-array design for binary beam acquisition of reconfigurable intelligent surfaces). In some examples, the transmitter 1115 may be co-located with a receiver 1110 in a transceiver module. The transmitter 1115 may utilize a single antenna or a set of multiple antennas.

The communications manager 1120, the receiver 1110, the transmitter 1115, or various combinations thereof or various components thereof may be examples of means for performing various aspects of multi-array design for binary beam acquisition of reconfigurable intelligent surfaces as described herein. For example, the communications manager 1120, the receiver 1110, the transmitter 1115, or various combinations or components thereof may support a method for performing one or more of the functions described herein.

In some examples, the communications manager 1120, the receiver 1110, the transmitter 1115, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1120, the receiver 1110, the transmitter 1115, or various combinations or components thereof may be implemented in code (e.g., as communications management software or firmware) executed by a processor. If implemented in code executed by a processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication in accordance with examples as disclosed herein. For example, the communications manager 1120 may be configured as or otherwise support a means for receiving, from a network entity at a control unit associated with a reconfigurable intelligent surface, a set of multiple reference signals via a set of multiple receive beams. The communications manager 1120 may be configured as or otherwise support a means for acquiring, via a first antenna panel associated with the control unit, a first beam of the set of multiple receive beams. The communications manager 1120 may be configured as or otherwise support a means for acquiring, via a second antenna panel associated with the control unit, a second beam of the set of multiple receive beams. The communications manager 1120 may be configured as or otherwise support a means for determining reflection coefficients of the reconfigurable intelligent surface for communication with the network entity based on the acquiring of the first beam and the acquiring of the second beam. The communications manager 1120 may be configured as or otherwise support a means for communicating via the reconfigurable intelligent surface based on the reflection coefficients of the reconfigurable intelligent surface.

By including or configuring the communications manager 1120 in accordance with examples as described herein, the device 1105 (e.g., a processor controlling or otherwise coupled with the receiver 1110, the transmitter 1115, the communications manager 1120, or a combination thereof) may support techniques for improvements in system efficiency such that a device may improve one or more aspects of communication (e.g., increased signal quality, increased throughput, increased transmission efficiency, increased power savings) between a RIS, a network entity, UE, based on the RIS being configured in accordance with RIS active antenna beam acquisition. Additionally, described techniques may result in reduced processing, reduced power consumption, more efficient utilization of communication resources.

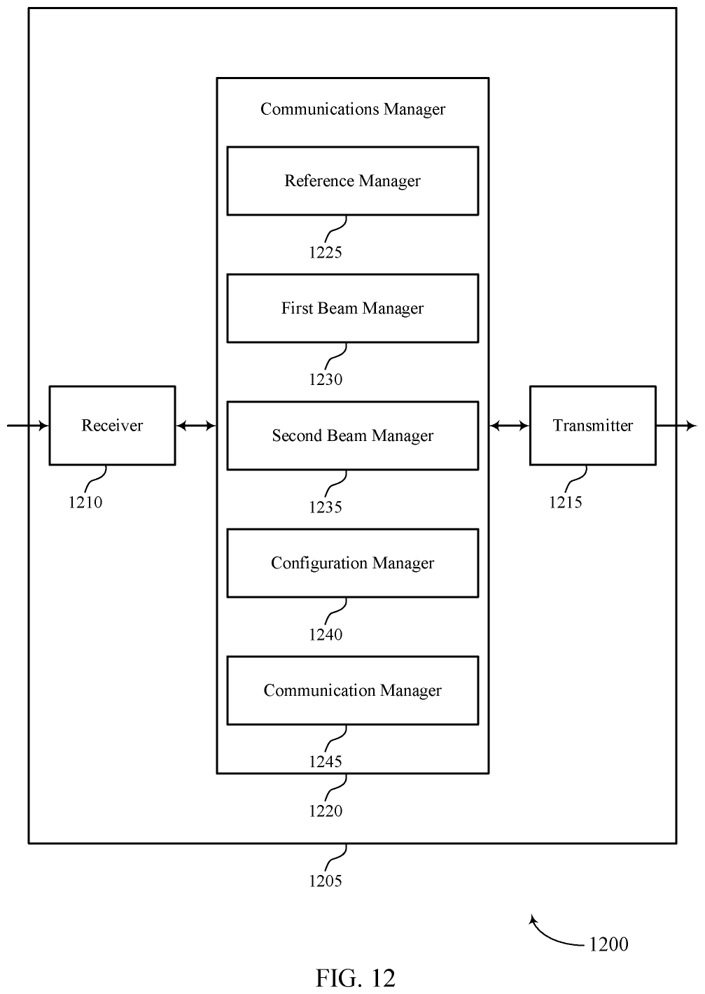

FIG. 12 shows a block diagram 1200 of a device 1205 that supports multi-array design for binary beam acquisition of reconfigurable intelligent surfaces in accordance with one or more aspects of the present disclosure. The device 1205 may be an example of aspects of a device 1105 or a control unit as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for receiving information such as packets, user data, control information, or any combination thereof associated with various information channels (e.g., control channels, data channels, information channels related to multi-array design for binary beam acquisition of reconfigurable intelligent surfaces). Information may be passed on to other components of the device 1205. The receiver 1210 may utilize a single antenna or a set of multiple antennas.

The transmitter 1215 may provide a means for transmitting signals generated by other components of the device 1205. For example, the transmitter 1215 may transmit information such as packets, user data, control information, or any combination thereof associated with various information channels (e.g., control channels, data channels, information channels related to multi-array design for binary beam acquisition of reconfigurable intelligent surfaces). In some examples, the transmitter 1215 may be co-located with a receiver 1210 in a transceiver module. The transmitter 1215 may utilize a single antenna or a set of multiple antennas.

The device 1205, or various components thereof, may be an example of means for performing various aspects of multi-array design for binary beam acquisition of reconfigurable intelligent surfaces as described herein. For example, the communications manager 1220 may include a reference manager 1225, a first beam manager 1230, a second beam manager 1235, a configuration manager 1240, a communication manager 1245, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communication in accordance with examples as disclosed herein. The reference manager 1225 may be configured as or otherwise support a means for receiving, from a network entity at a control unit associated with a reconfigurable intelligent surface, a set of multiple reference signals via a set of multiple receive beams. The first beam manager 1230 may be configured as or otherwise support a means for acquiring, via a first antenna panel associated with the control unit, a first beam of the set of multiple receive beams. The second beam manager 1235 may be configured as or otherwise support a means for acquiring, via a second antenna panel associated with the control unit, a second beam of the set of multiple receive beams. The configuration manager 1240 may be configured as or otherwise support a means for determining reflection coefficients of the reconfigurable intelligent surface for communication with the network entity based on the acquiring of the first beam and the acquiring of the second beam. The communication manager 1245 may be configured as or otherwise support a means for communicating via the reconfigurable intelligent surface based on the reflection coefficients of the reconfigurable intelligent surface.

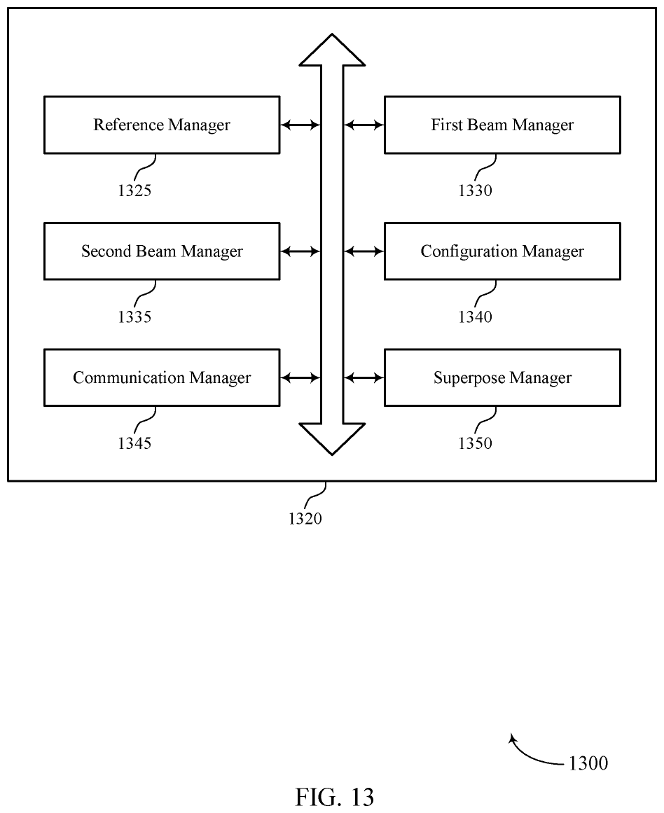

FIG. 13 shows a block diagram 1300 of a communications manager 1320 that supports multi-array design for binary beam acquisition of reconfigurable intelligent surfaces in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of multi-array design for binary beam acquisition of reconfigurable intelligent surfaces as described herein. For example, the communications manager 1320 may include a reference manager 1325, a first beam manager 1330, a second beam manager 1335, a configuration manager 1340, a communication manager 1345, a superpose manager 1350, or any combination thereof. Each of these components may communicate, directly or indirectly, with one another (e.g., via one or more buses).

The communications manager 1320 may support wireless communication in accordance with examples as disclosed herein. The reference manager 1325 may be configured as or otherwise support a means for receiving, from a network entity at a control unit associated with a reconfigurable intelligent surface, a set of multiple reference signals via a set of multiple receive beams. The first beam manager 1330 may be configured as or otherwise support a means for acquiring, via a first antenna panel associated with the control unit, a first beam of the set of multiple receive beams. The second beam manager 1335 may be configured as or otherwise support a means for acquiring, via a second antenna panel associated with the control unit, a second beam of the set of multiple receive beams. The configuration manager 1340 may be configured as or otherwise support a means for determining reflection coefficients of the reconfigurable intelligent surface for communication with the network entity based on the acquiring of the first beam and the acquiring of the second beam. The communication manager 1345 may be configured as or otherwise support a means for communicating via the reconfigurable intelligent surface based on the reflection coefficients of the reconfigurable intelligent surface.

In some examples, the superpose manager 1350 may be configured as or otherwise support a means for superposing the first beam in relation to the second beam, where determining the reflection coefficients is based on identifying a beam of the reconfigurable intelligent surface that corresponds to the superposing of the first beam and the second beam.

In some examples, the superpose manager 1350 may be configured as or otherwise support a means for receiving, prior to receiving the set of multiple reference signals and based on the superposing of the first beam and the second beam, a channel state information reference signal resource set indicating a repetition parameter set to on and a reporting parameter set to off, where the set of multiple reference signals include a set of multiple channel state information reference signals.

In some examples, the superpose manager 1350 may be configured as or otherwise support a means for performing, via the first antenna panel and the second antenna panel and based on the channel state information reference signal resource set, beam sweep measurements on the set of multiple reference signals received concurrently at the first antenna panel and at the second antenna panel, where the acquiring of the first beam and the acquiring of the second beam is based on the beam sweep measurements.

In some examples, the first antenna panel includes a narrow panel configuration with a first inter-element spacing. In some examples, the second antenna panel includes a wide panel configuration with a second inter-element spacing, the second inter-element spacing being larger than the first inter-element spacing.

In some examples, the first inter-element spacing and the second inter-element spacing are larger than an inter-element spacing of an antenna panel of the reconfigurable intelligent surface.

In some examples, the control unit includes a first radio frequency chain for the first antenna panel and a second radio frequency chain for the second antenna panel. In some examples, the first antenna panel and the second antenna panel have fewer antenna elements than an antenna panel of the reconfigurable intelligent surface. In some examples, the first antenna panel or the second antenna panel, or both, have receiver capability or have receiver capability and transmitter capability. In some examples, the control unit of the reconfigurable intelligent surface includes logarithm N sub-arrays, each sub-array including multiple antenna elements that are configured in different directions.

In some examples, the reconfigurable intelligent surface is configured with a number of elements determined based on a value of N squared. In some examples, a number of antennas at the control unit is based on a base-2 logarithm of N. In some examples, the antennas at the control unit configure the number of elements at the reconfigurable intelligent surface.

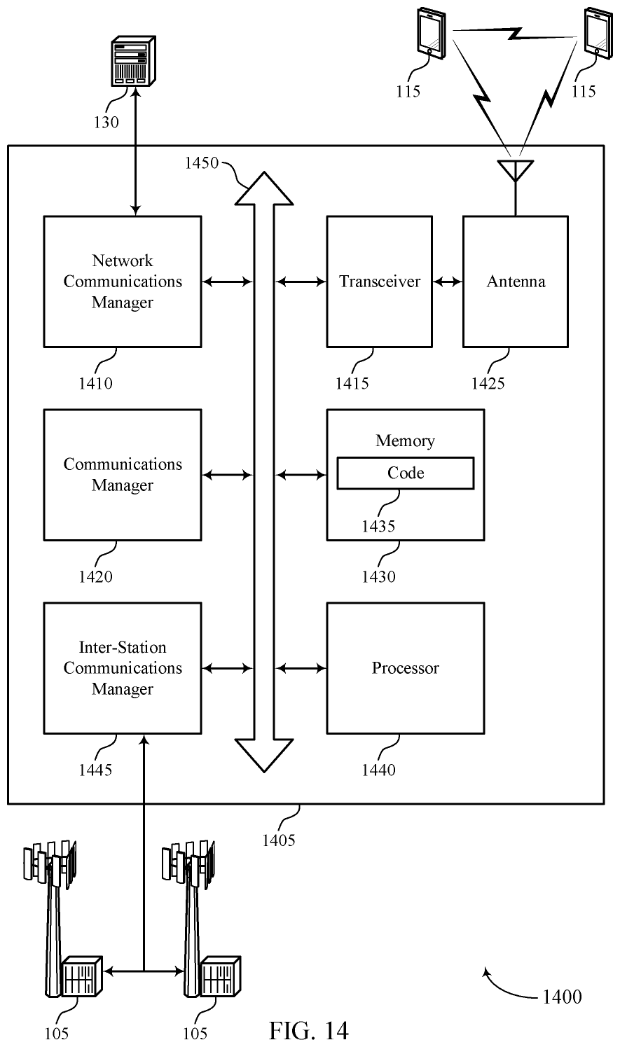

FIG. 14 shows a diagram of a system 1400 including a device 1405 that supports multi-array design for binary beam acquisition of reconfigurable intelligent surfaces in accordance with one or more aspects of the present disclosure. The device 1405 may be an example of or include the components of a device 1105, a device 1205, or a control unit as described herein. The device 1405 may include components for bi-directional voice and data communications including components for transmitting and receiving communications, such as a communications manager 1420, a network communications manager 1410, a transceiver 1415, an antenna 1425, a memory 1430, code 1435, a processor 1440, and an inter-station communications manager 1445. These components may be in electronic communication or otherwise coupled (e.g., operatively, communicatively, functionally, electronically, electrically) via one or more buses (e.g., a bus 1450).

The network communications manager 1410 may manage communications with a core network 130 (e.g., via one or more wired backhaul links). For example, the network communications manager 1410 may manage the transfer of data communications for client devices, such as one or more UEs 115.

In some cases, the device 1405 may include a single antenna 1425. However, in some other cases the device 1405 may have more than one antenna 1425, which may be capable of concurrently transmitting or receiving multiple wireless transmissions. The transceiver 1415 may communicate bi-directionally, via the one or more antennas 1425, wired, or wireless links as described herein. For example, the transceiver 1415 may represent a wireless transceiver and may communicate bi-directionally with another wireless transceiver. The transceiver 1415 may also include a modem to modulate the packets, to provide the modulated packets to one or more antennas 1425 for transmission, and to demodulate packets received from the one or more antennas 1425. The transceiver 1415, or the transceiver 1415 and one or more antennas 1425, may be an example of a transmitter 1115, a transmitter 1215, a receiver 1110, a receiver 1210, or any combination thereof or component thereof, as described herein.

The memory 1430 may include RAM and ROM. The memory 1430 may store computer-readable, computer-executable code 1435 including instructions that, when executed by the processor 1440, cause the device 1405 to perform various functions described herein. The code 1435 may be stored in a non-transitory computer-readable medium such as system memory or another type of memory. In some cases, the code 1435 may not be directly executable by the processor 1440 but may cause a computer (e.g., when compiled and executed) to perform functions described herein. In some cases, the memory 1430 may contain, among other things, a BIOS which may control basic hardware or software operation such as the interaction with peripheral components or devices.

The processor 1440 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1440 may be configured to operate a memory array using a memory controller. In some other cases, a memory controller may be integrated into the processor 1440. The processor 1440 may be configured to execute computer-readable instructions stored in a memory (e.g., the memory 1430) to cause the device 1405 to perform various functions (e.g., functions or tasks supporting multi-array design for binary beam acquisition of reconfigurable intelligent surfaces). For example, the device 1405 or a component of the device 1405 may include a processor 1440 and memory 1430 coupled to the processor 1440, the processor 1440 and memory 1430 configured to perform various functions described herein.

The inter-station communications manager 1445 may manage

communications with other base stations 105, and may include a controller or scheduler for controlling communications with UEs 115 in cooperation with other base stations 105. For example, the inter-station communications manager 1445 may coordinate scheduling for transmissions to UEs 115 for various interference mitigation techniques such as beamforming or joint transmission. In some examples, the inter-station communications manager 1445 may provide an X2 interface within an LTE/LTE-A wireless communications network technology to provide communication between base stations 105.

The communications manager 1420 may support wireless communication in accordance with examples as disclosed herein. For example, the communications manager 1420 may be configured as or otherwise support a means for receiving, from a network entity at a control unit associated with a reconfigurable intelligent surface, a set of multiple reference signals via a set of multiple receive beams. The communications manager 1420 may be configured as or otherwise support a means for acquiring, via a first antenna panel associated with the control unit, a first beam of the set of multiple receive beams. The communications manager 1420 may be configured as or otherwise support a means for acquiring, via a second antenna panel associated with the control unit, a second beam of the set of multiple receive beams. The communications manager 1420 may be configured as or otherwise support a means for determining reflection coefficients of the reconfigurable intelligent surface for communication with the network entity based on the acquiring of the first beam and the acquiring of the second beam. The communications manager 1420 may be configured as or otherwise support a means for communicating via the reconfigurable intelligent surface based on the reflection coefficients of the reconfigurable intelligent surface.

By including or configuring the communications manager 1420 in accordance with examples as described herein, the device 1405 may support techniques for improvements in system efficiency such that a device may improve one or more aspects of communication (e.g., increased signal quality, increased throughput, increased transmission efficiency, increased power savings) between a RIS, a network entity, UE, based on the RIS being configured in accordance with RIS active antenna beam acquisition. Additionally, described techniques may result in improved communication reliability, reduced latency, improved user experience related to reduced processing, reduced power consumption, more efficient utilization of communication resources, improved coordination between devices, longer battery life, improved utilization of processing capability.

In some examples, the communications manager 1420 may be configured to perform various operations (e.g., receiving, monitoring, transmitting) using or otherwise in cooperation with the transceiver 1415, the one or more antennas 1425, or any combination thereof. Although the communications manager 1420 is illustrated as a separate component, in some examples, one or more functions described with reference to the communications manager 1420 may be supported by or performed by the processor 1440, the memory 1430, the code 1435, or any combination thereof. For example, the code 1435 may include instructions executable by the processor 1440 to cause the device 1405 to perform various aspects of multi-array design for binary beam acquisition of reconfigurable intelligent surfaces as described herein, or the processor 1440 and the memory 1430 may be otherwise configured to perform or support such operations.

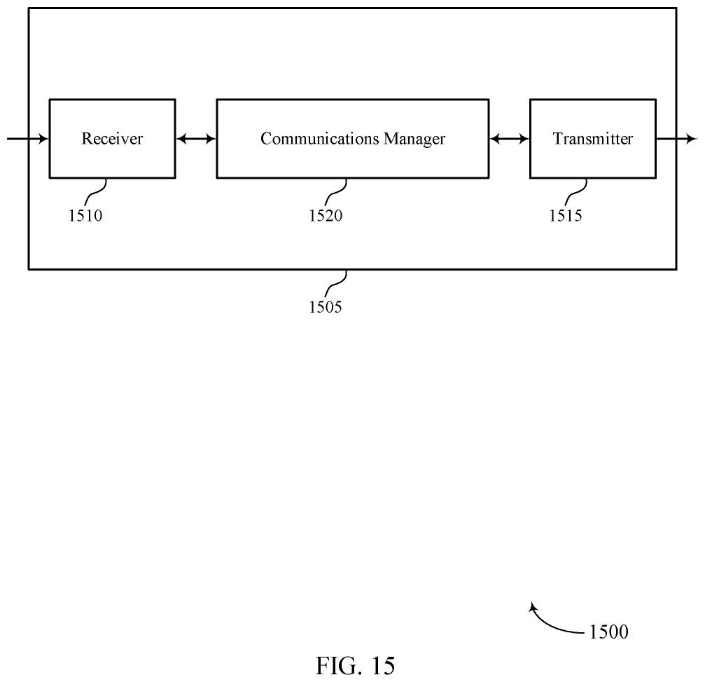

FIG. 15 shows a block diagram 1500 of a device 1505 that supports multi-array design for binary beam acquisition of reconfigurable intelligent surfaces in accordance with one or more aspects of the present disclosure. The device 1505 may be an example of aspects of a network entity or base station 105 as described herein. The device 1505 may include a receiver 1510, a transmitter 1515, and a communications manager 1520. The device 1505 may also include a processor. Each of these components may be in communication with one another (e.g., via one or more buses).

The receiver 1510 may provide a means for receiving information such as packets, user data, control information, or any combination thereof associated with various information channels (e.g., control channels, data channels, information channels related to multi-array design for binary beam acquisition of reconfigurable intelligent surfaces). Information may be passed on to other components of the device 1505. The receiver 1510 may utilize a single antenna or a set of multiple antennas.

The transmitter 1515 may provide a means for transmitting signals generated by other components of the device 1505. For example, the transmitter 1515 may transmit information such as packets, user data, control information, or any combination thereof associated with various information channels (e.g., control channels, data channels, information channels related to multi-array design for binary beam acquisition of reconfigurable intelligent surfaces). In some examples, the transmitter 1515 may be co-located with a receiver 1510 in a transceiver module. The transmitter 1515 may utilize a single antenna or a set of multiple antennas.

The communications manager 1520, the receiver 1510, the transmitter 1515, or various combinations thereof or various components thereof may be examples of means for performing various aspects of multi-array design for binary beam acquisition of reconfigurable intelligent surfaces as described herein. For example, the communications manager 1520, the receiver 1510, the transmitter 1515, or various combinations or components thereof may support a method for performing one or more of the functions described herein.

In some examples, the communications manager 1520, the receiver 1510, the transmitter 1515, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1520, the receiver 1510, the transmitter 1515, or various combinations or components thereof may be implemented in code (e.g., as communications management software or firmware) executed by a processor. If implemented in code executed by a processor, the functions of the communications manager 1520, the receiver 1510, the transmitter 1515, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1520 may be configured to perform various operations (e.g., receiving, obtaining, monitoring, outputting, transmitting) using or otherwise in cooperation with the receiver 1510, the transmitter 1515, or both. For example, the communications manager 1520 may receive information from the receiver 1510, send information to the transmitter 1515, or be integrated in combination with the receiver 1510, the transmitter 1515, or both to obtain information, output information, or perform various other operations as described herein.

The communications manager 1520 may support wireless communication in accordance with examples as disclosed herein. For example, the communications manager 1520 may be configured as or otherwise support a means for receiving, at a network entity, a set of multiple reference signals transmitted from a control unit associated with a reconfigurable intelligent surface via a set of multiple beams. The communications manager 1520 may be configured as or otherwise support a means for selecting a first beam of the set of multiple beams for a first antenna panel associated with the control unit. The communications manager 1520 may be configured as or otherwise support a means for selecting a second beam of the set of multiple beams for a second antenna panel associated with the control unit. The communications manager 1520 may be configured as or otherwise support a means for signaling, to the control unit, a configuration of the reconfigurable intelligent surface determined based on the first beam and the second beam.

Additionally, or alternatively, the communications manager 1520 may support wireless communication in accordance with examples as disclosed herein. For example, the communications manager 1520 may be configured as or otherwise support a means for transmitting, to a network entity from a control unit associated with a reconfigurable intelligent surface, a set of multiple reference signals including a first set of reference signals transmitted via a first antenna panel associated with the control unit and a second set of reference signals transmitted via a second antenna panel associated with the control unit. The communications manager 1520 may be configured as or otherwise support a means for receiving, from the control unit, a configuration of the reconfigurable intelligent surface. The communications manager 1520 may be configured as or otherwise support a means for configuring the reconfigurable intelligent surface for communication with the network entity based on the configuration of the reconfigurable intelligent surface.

By including or configuring the communications manager 1520 in accordance with examples as described herein, the device 1505 (e.g., a processor controlling or otherwise coupled with the receiver 1510, the transmitter 1515, the communications manager 1520, or a combination thereof) may support techniques for improvements in system efficiency such that a device may improve one or more aspects of communication (e.g., increased signal quality, increased throughput, increased transmission efficiency, increased power savings) between a RIS, a network entity, UE, based on the RIS being configured in accordance with RIS active antenna beam acquisition. Additionally, described techniques may result in reduced processing, reduced power consumption, more efficient utilization of communication resources.

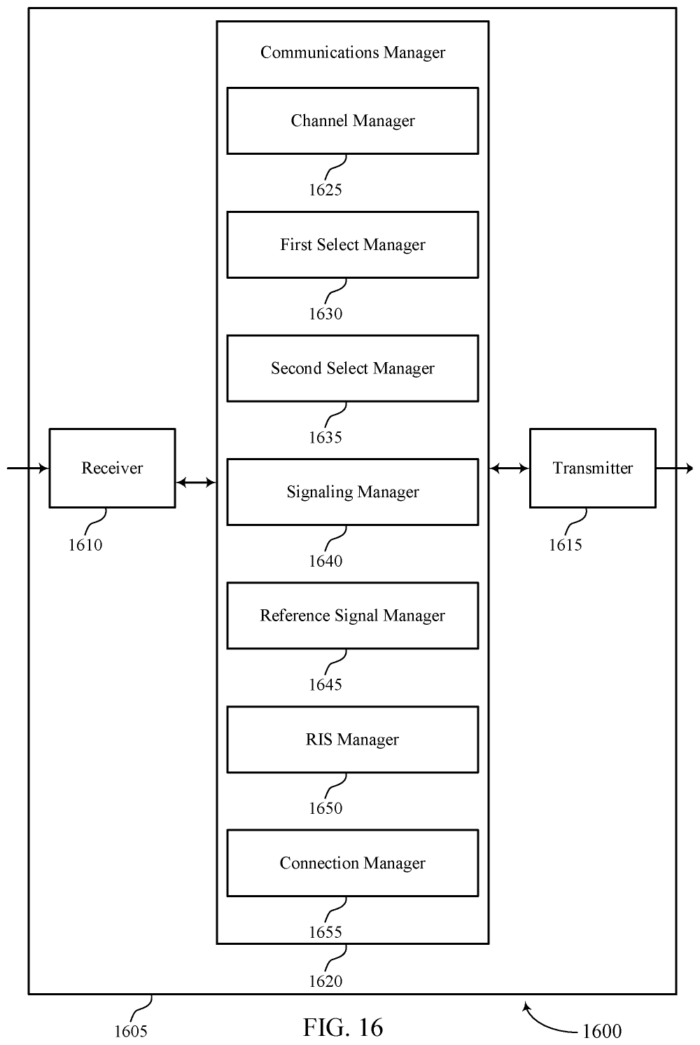

FIG. 16 shows a block diagram 1600 of a device 1605 that supports multi-array design for binary beam acquisition of reconfigurable intelligent surfaces in accordance with one or more aspects of the present disclosure. The device 1605 may be an example of aspects of a device 1505, or a network entity, or base station 105 as described herein. The device 1605 may include a receiver 1610, a transmitter 1615, and a communications manager 1620. The device 1605 may also include a processor. Each of these components may be in communication with one another (e.g., via one or more buses).

The receiver 1610 may provide a means for receiving information such as packets, user data, control information, or any combination thereof associated with various information channels (e.g., control channels, data channels, information channels related to multi-array design for binary beam acquisition of reconfigurable intelligent surfaces). Information may be passed on to other components of the device 1605. The receiver 1610 may utilize a single antenna or a set of multiple antennas.

The transmitter 1615 may provide a means for transmitting signals generated by other components of the device 1605. For example, the transmitter 1615 may transmit information such as packets, user data, control information, or any combination thereof associated with various information channels (e.g., control channels, data channels, information channels related to multi-array design for binary beam acquisition of reconfigurable intelligent surfaces). In some examples, the transmitter 1615 may be co-located with a receiver 1610 in a transceiver module. The transmitter 1615 may utilize a single antenna or a set of multiple antennas.

The device 1605, or various components thereof, may be an example of means for performing various aspects of multi-array design for binary beam acquisition of reconfigurable intelligent surfaces as described herein. For example, the communications manager 1620 may include a channel manager 1625, a first select manager 1630, a second select manager 1635, a signaling manager 1640, a reference signal manager 1645, a RIS manager 1650, a connection manager 1655, or any combination thereof. The communications manager 1620 may be an example of aspects of a communications manager 1520 as described herein. In some examples, the communications manager 1620, or various components thereof, may be configured to perform various operations (e.g., receiving, obtaining, monitoring, outputting, transmitting) using or otherwise in cooperation with the receiver 1610, the transmitter 1615, or both. For example, the communications manager 1620 may receive information from the receiver 1610, send information to the transmitter 1615, or be integrated in combination with the receiver 1610, the transmitter 1615, or both to obtain information, output information, or perform various other operations as described herein.

The communications manager 1620 may support wireless communication in accordance with examples as disclosed herein. The channel manager 1625 may be configured as or otherwise support a means for receiving, at a network entity, a set of multiple reference signals transmitted from a control unit associated with a reconfigurable intelligent surface via a set of multiple beams. The first select manager 1630 may be configured as or otherwise support a means for selecting a first beam of the set of multiple beams for a first antenna panel associated with the control unit. The second select manager 1635 may be configured as or otherwise support a means for selecting a second beam of the set of multiple beams for a second antenna panel associated with the control unit. The signaling manager 1640 may be configured as or otherwise support a means for signaling, to the control unit, a configuration of the reconfigurable intelligent surface determined based on the first beam and the second beam.

Additionally, or alternatively, the communications manager 1620 may support wireless communication in accordance with examples as disclosed herein. The reference signal manager 1645 may be configured as or otherwise support a means for transmitting, to a network entity from a control unit associated with a reconfigurable intelligent surface, a set of multiple reference signals including a first set of reference signals transmitted via a first antenna panel associated with the control unit and a second set of reference signals transmitted via a second antenna panel associated with the control unit. The RIS manager 1650 may be configured as or otherwise support a means for receiving, from the control unit, a configuration of the reconfigurable intelligent surface. The connection manager 1655 may be configured as or otherwise support a means for configuring the reconfigurable intelligent surface for communication with the network entity based on the configuration of the reconfigurable intelligent surface.

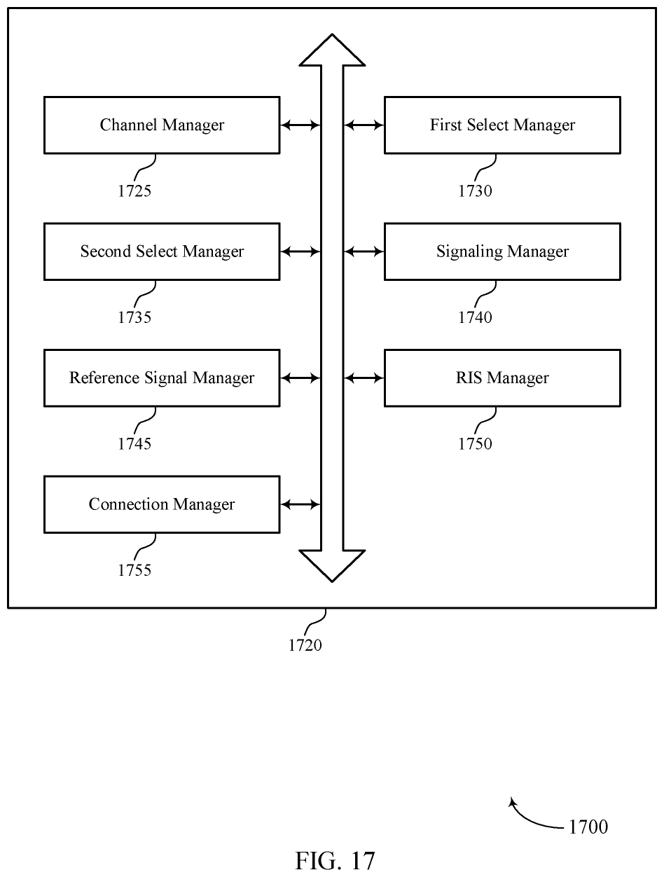

FIG. 17 shows a block diagram 1700 of a communications manager 1720 that supports multi-array design for binary beam acquisition of reconfigurable intelligent surfaces in accordance with one or more aspects of the present disclosure. The communications manager 1720 may be an example of aspects of a communications manager 1520, a communications manager 1620, or both, as described herein. The communications manager 1720, or various components thereof, may be an example of means for performing various aspects of multi-array design for binary beam acquisition of reconfigurable intelligent surfaces as described herein. For example, the communications manager 1720 may include a channel manager 1725, a first select manager 1730, a second select manager 1735, a signaling manager 1740, a reference signal manager 1745, a RIS manager 1750, a connection manager 1755, or any combination thereof. Each of these components may communicate, directly or indirectly, with one another (e.g., via one or more buses).

The communications manager 1720 may support wireless communication in accordance with examples as disclosed herein. The channel manager 1725 may be configured as or otherwise support a means for receiving, at a network entity, a set of multiple reference signals transmitted from a control unit associated with a reconfigurable intelligent surface via a set of multiple beams. The first select manager 1730 may be configured as or otherwise support a means for selecting a first beam of the set of multiple beams for a first antenna panel associated with the control unit. The second select manager 1735 may be configured as or otherwise support a means for selecting a second beam of the set of multiple beams for a second antenna panel associated with the control unit. The signaling manager 1740 may be configured as or otherwise support a means for signaling, to the control unit, a configuration of the reconfigurable intelligent surface determined based on the first beam and the second beam.

In some examples, the configuration of the reconfigurable intelligent surface includes reflection coefficients associated with the first antenna panel, reflection coefficients associated with the second antenna panel, a first transmit precoding matrix index associated with the first antenna panel, a second transmit precoding matrix index associated with the second antenna panel, or a transmit precoding matrix index associated with the reconfigurable intelligent surface, or any combination thereof.

In some examples, the channel manager 1725 may be configured as or otherwise support a means for receiving, prior to receiving the set of multiple reference signals, a configuration of the first antenna panel and the second antenna panel and a configuration of the reconfigurable intelligent surface.

In some examples, the channel manager 1725 may be configured as or otherwise support a means for transmitting, to the control unit based on receiving the configuration of the first antenna panel and the second antenna panel, a first sounding reference signal resource set that indicates uplink beam management associated with the first antenna panel and a second sounding reference signal resource set that indicates uplink beam management associated with the second antenna panel.

In some examples, the configuration of the first antenna panel and the second antenna panel indicate an inter-element spacing of the first antenna panel, an inter-element spacing of the second antenna panel, a number of antennas associated with the first antenna panel, or a number of antennas associated with the second antenna panel, or any combination thereof. In some examples, the configuration of the reconfigurable intelligent surface indicates an inter-element spacing of elements (e.g., reflective elements) of the reconfigurable intelligent surface, or a number of elements associated with the reconfigurable intelligent surface, or both.

Additionally, or alternatively, the communications manager 1720 may support wireless communication in accordance with examples as disclosed herein. The reference signal manager 1745 may be configured as or otherwise support a means for transmitting, to a network entity from a control unit associated with a reconfigurable intelligent surface, a set of multiple reference signals including a first set of reference signals transmitted via a first antenna panel associated with the control unit and a second set of reference signals transmitted via a second antenna panel associated with the control unit. The RIS manager 1750 may be configured as or otherwise support a means for receiving, from the control unit, a configuration of the reconfigurable intelligent surface. The connection manager 1755 may be configured as or otherwise support a means for configuring the reconfigurable intelligent surface for communication with the network entity based on the configuration of the reconfigurable intelligent surface.

In some examples, the configuration of the reconfigurable intelligent surface includes reflection coefficients associated with the first antenna panel, reflection coefficients associated with the second antenna panel, a first transmit precoding matrix index associated with the first antenna panel, a second transmit precoding matrix index associated with the second antenna panel, or a transmit precoding matrix index associated with the reconfigurable intelligent surface, or any combination thereof.

In some examples, the RIS manager 1750 may be configured as or otherwise support a means for transmitting, prior to receiving the set of multiple reference signals, a configuration of the first antenna panel and the second antenna panel and a configuration of the reconfigurable intelligent surface.

In some examples, the RIS manager 1750 may be configured as or otherwise support a means for receiving, from the network entity based on transmitting the configuration of the first antenna panel and the second antenna panel, a first sounding reference signal resource set that indicates uplink beam management associated with the first antenna panel and a second sounding reference signal resource set that indicates uplink beam management associated with the second antenna panel.

In some examples, the configuration of the first antenna panel and the second antenna panel indicate an inter-element spacing of the first antenna panel, an inter-element spacing of the second antenna panel, a number of antennas associated with the first antenna panel, or a number of antennas associated with the second antenna panel, or any combination thereof. In some examples, the configuration of the reconfigurable intelligent surface indicates an inter-element spacing of elements of the reconfigurable intelligent surface, or a number of elements associated with the antenna panel of the reconfigurable intelligent surface, or both.

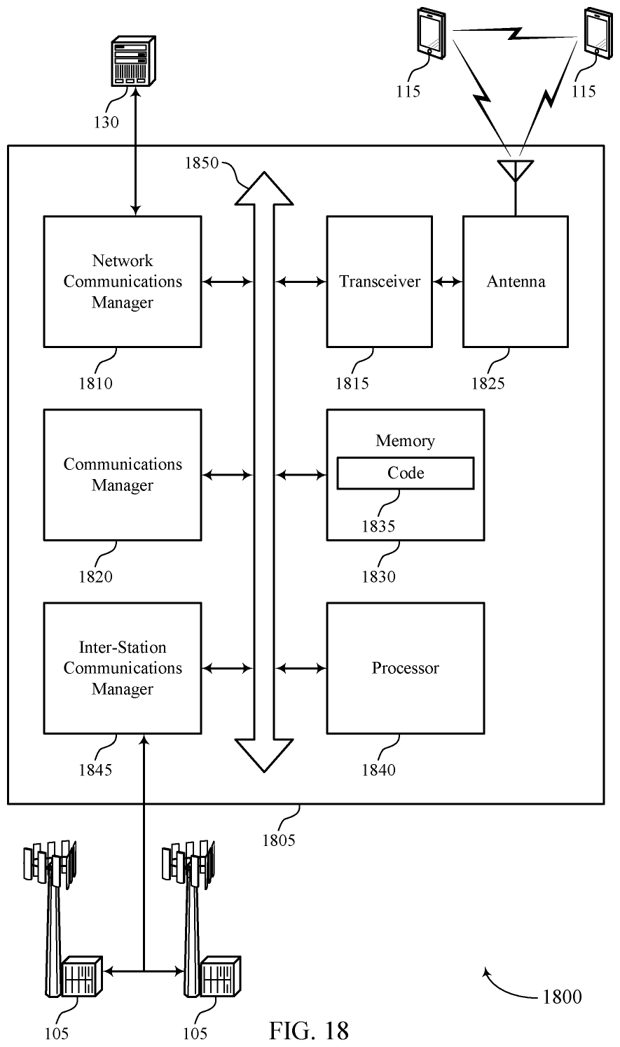

FIG. 18 shows a diagram of a system 1800 including a device 1805 that supports multi-array design for binary beam acquisition of reconfigurable intelligent surfaces in accordance with one or more aspects of the present disclosure. The device 1805 may be an example of or include the components of a device 1505, a device 1605, a network entity, or a base station 105 as described herein. The device 1805 may communicate (e.g., wirelessly) with one or more network entities 105, one or more UEs 115, or any combination thereof. The device 1805 may include components for bi-directional voice and data communications including components for transmitting and receiving communications, such as a communications manager 1820, a network communications manager 1810, a transceiver 1815, an antenna 1825, a memory 1830, code 1835, a processor 1840, and an inter-station communications manager 1845. These components may be in electronic communication or otherwise coupled (e.g., operatively, communicatively, functionally, electronically, electrically) via one or more buses (e.g., a bus 1850).

The network communications manager 1810 may manage communications with a core network 130 (e.g., via one or more wired backhaul links). For example, the network communications manager 1810 may manage the transfer of data communications for client devices, such as one or more UEs 115.

In some cases, the device 1805 may include a single antenna 1825. However, in some other cases the device 1805 may have more than one antenna 1825, which may be capable of concurrently transmitting or receiving multiple wireless transmissions. The transceiver 1815 may communicate bi-directionally, via the one or more antennas 1825, wired, or wireless links as described herein. For example, the transceiver 1815 may represent a wireless transceiver and may communicate bi-directionally with another wireless transceiver. The transceiver 1815 may also include a modem to modulate the packets, to provide the modulated packets to one or more antennas 1825 for transmission, and to demodulate packets received from the one or more antennas 1825. The transceiver 1815, or the transceiver 1815 and one or more antennas 1825, may be an example of a transmitter 1515, a transmitter 1615, a receiver 1510, a receiver 1610, or any combination thereof or component thereof, as described herein.

The memory 1830 may include RAM and ROM. The memory 1830 may store computer-readable, computer-executable code 1835 including instructions that, when executed by the processor 1840, cause the device 1805 to perform various functions described herein. The code 1835 may be stored in a non-transitory computer-readable medium such as system memory or another type of memory. In some cases, the code 1835 may not be directly executable by the processor 1840 but may cause a computer (e.g., when compiled and executed) to perform functions described herein. In some cases, the memory 1830 may contain, among other things, a BIOS which may control basic hardware or software operation such as the interaction with peripheral components or devices.

The processor 1840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1840 may be configured to operate a memory array using a memory controller. In some other cases, a memory controller may be integrated into the processor 1840. The processor 1840 may be configured to execute computer-readable instructions stored in a memory (e.g., the memory 1830) to cause the device 1805 to perform various functions (e.g., functions or tasks supporting multi-array design for binary beam acquisition of reconfigurable intelligent surfaces). For example, the device 1805 or a component of the device 1805 may include a processor 1840 and memory 1830 coupled with or to the processor 1840, the processor 1840 and memory 1830 configured to perform various functions described herein.

The inter-station communications manager 1845 may manage communications with other base stations 105, and may include a controller or scheduler for controlling communications with UEs 115 in cooperation with other base stations 105. For example, the inter-station communications manager 1845 may coordinate scheduling for transmissions to UEs 115 for various interference mitigation techniques such as beamforming or joint transmission. In some examples, the inter-station communications manager 1845 may provide an X2 interface within an LTE/LTE-A wireless communications network technology to provide communication between base stations 105.

The communications manager 1820 may support wireless communication in accordance with examples as disclosed herein. For example, the communications manager 1820 may be configured as or otherwise support a means for receiving, at a network entity, a set of multiple reference signals transmitted from a control unit associated with a reconfigurable intelligent surface via a set of multiple beams. The communications manager 1820 may be configured as or otherwise support a means for selecting a first beam of the set of multiple beams for a first antenna panel associated with the control unit. The communications manager 1820 may be configured as or otherwise support a means for selecting a second beam of the set of multiple beams for a second antenna panel associated with the control unit. The communications manager 1820 may be configured as or otherwise support a means for signaling, to the control unit, a configuration of the reconfigurable intelligent surface determined based on the first beam and the second beam.

Additionally, or alternatively, the communications manager 1820 may support wireless communication in accordance with examples as disclosed herein. For example, the communications manager 1820 may be configured as or otherwise support a means for transmitting, to a network entity from a control unit associated with a reconfigurable intelligent surface, a set of multiple reference signals including a first set of reference signals transmitted via a first antenna panel associated with the control unit and a second set of reference signals transmitted via a second antenna panel associated with the control unit. The communications manager 1820 may be configured as or otherwise support a means for receiving, from the control unit, a configuration of the reconfigurable intelligent surface. The communications manager 1820 may be configured as or otherwise support a means for configuring the reconfigurable intelligent surface for communication with the network entity based on the configuration of the reconfigurable intelligent surface.

By including or configuring the communications manager 1820 in accordance with examples as described herein, the device 1805 may support techniques for improvements in system efficiency such that a device may improve one or more aspects of communication (e.g., increased signal quality, increased throughput, increased transmission efficiency, increased power savings) between a RIS, a network entity, UE, based on the RIS being configured in accordance with RIS active antenna beam acquisition. Additionally, described techniques may result in improved communication reliability, reduced latency, improved user experience related to reduced processing, reduced power consumption, more efficient utilization of communication resources, improved coordination between devices, longer battery life, improved utilization of processing capability.

In some examples, the communications manager 1820 may be configured to perform various operations (e.g., receiving, monitoring, transmitting) using or otherwise in cooperation with the transceiver 1815, the one or more antennas 1825, or any combination thereof. Although the communications manager 1820 is illustrated as a separate component, in some examples, one or more functions described with reference to the communications manager 1820 may be supported by or performed by the processor 1840, the memory 1830, the code 1835, or any combination thereof. For example, the code 1835 may include instructions executable by the processor 1840 to cause the device 1805 to perform various aspects of multi-array design for binary beam acquisition of reconfigurable intelligent surfaces as described herein, or the processor 1840 and the memory 1830 may be otherwise configured to perform or support such operations.

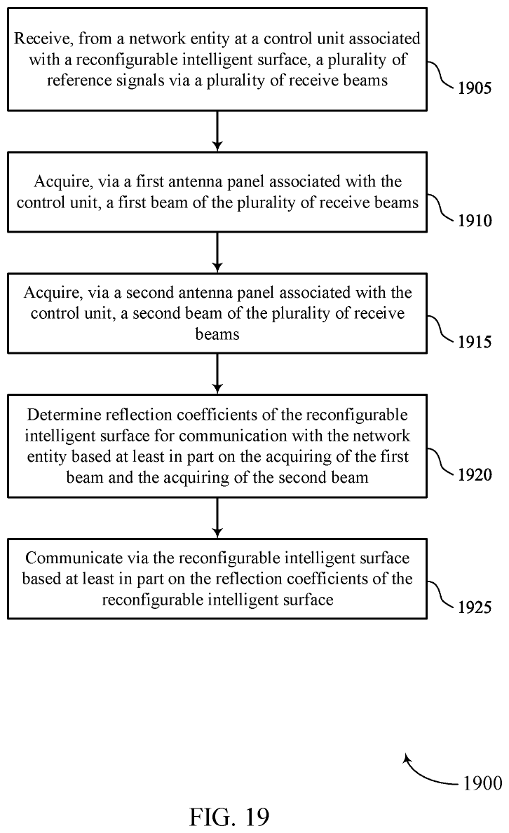

FIG. 19 shows a flowchart illustrating a method 1900 that supports multi-array design for binary beam acquisition of reconfigurable intelligent surfaces in accordance with one or more aspects of the present disclosure. The operations of the method 1900 may be implemented by a control unit or its components as described herein. For example, the operations of the method 1900 may be performed by a control unit as described with reference to FIGS. 1 through 14. In some examples, a control unit may execute a set of instructions to control the functional elements of the control unit to perform the described functions. Additionally, or alternatively, the control unit may perform aspects of the described functions using special-purpose hardware.

At 1905, the method may include receiving, from a network entity at a control unit associated with a reconfigurable intelligent surface, a set of multiple reference signals via a set of multiple receive beams. The operations of 1905 may be performed in accordance with examples as disclosed herein. In some examples, aspects of the operations of 1905 may be performed by a reference manager 1325 as described with reference to FIG. 13.

At 1910, the method may include acquiring, via a first antenna panel associated with the control unit, a first beam of the set of multiple receive beams. The operations of 1910 may be performed in accordance with examples as disclosed herein. In some examples, aspects of the operations of 1910 may be performed by a first beam manager 1330 as described with reference to FIG. 13.

At 1915, the method may include acquiring, via a second antenna panel associated with the control unit, a second beam of the set of multiple receive beams. The operations of 1915 may be performed in accordance with examples as disclosed herein. In some examples, aspects of the operations of 1915 may be performed by a second beam manager 1335 as described with reference to FIG. 13.

At 1920, the method may include determining reflection coefficients of the reconfigurable intelligent surface for communication with the network entity based on the acquiring of the first beam and the acquiring of the second beam. The operations of 1920 may be performed in accordance with examples as disclosed herein. In some examples, aspects of the operations of 1920 may be performed by a configuration manager 1340 as described with reference to FIG. 13.

At 1925, the method may include communicating via the reconfigurable intelligent surface based on the reflection coefficients of the reconfigurable intelligent surface. The operations of 1925 may be performed in accordance with examples as disclosed herein. In some examples, aspects of the operations of 1925 may be performed by a communication manager 1345 as described with reference to FIG. 13.

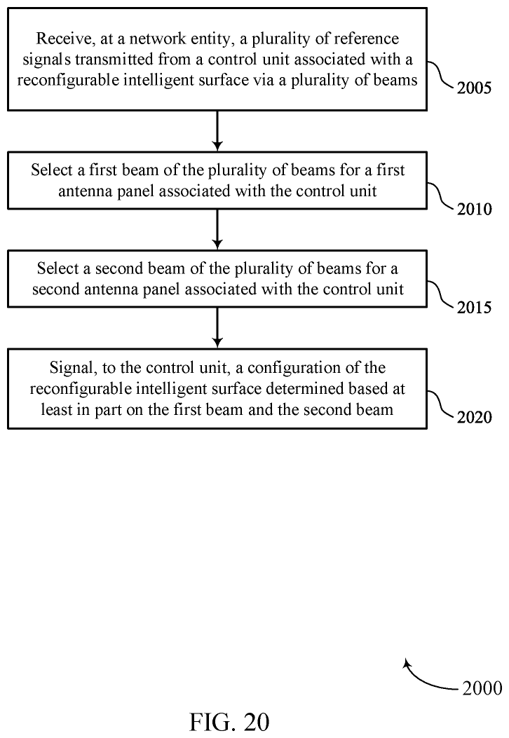

FIG. 20 shows a flowchart illustrating a method 2000 that supports multi-array design for binary beam acquisition of reconfigurable intelligent surfaces in accordance with one or more aspects of the present disclosure. The operations of the method 2000 may be implemented by a base station or its components as described herein. For example, the operations of the method 2000 may be performed by a base station 105 as described with reference to FIGS. 1 through 10 and 15 through 18. In some examples, a base station may execute a set of instructions to control the functional elements of the base station to perform the described functions. Additionally, or alternatively, the base station may perform aspects of the described functions using special-purpose hardware.

At 2005, the method may include receiving, at a network entity, a set of multiple reference signals transmitted from a control unit associated with a reconfigurable intelligent surface via a set of multiple beams. The operations of 2005 may be performed in accordance with examples as disclosed herein. In some examples, aspects of the operations of 2005 may be performed by a channel manager 1725 as described with reference to FIG. 17.

At 2010, the method may include selecting a first beam of the set of multiple beams for a first antenna panel associated with the control unit. The operations of 2010 may be performed in accordance with examples as disclosed herein. In some examples, aspects of the operations of 2010 may be performed by a first select manager 1730 as described with reference to FIG. 17.

At 2015, the method may include selecting a second beam of the set of multiple beams for a second antenna panel associated with the control unit. The operations of 2015 may be performed in accordance with examples as disclosed herein. In some examples, aspects of the operations of 2015 may be performed by a second select manager 1735 as described with reference to FIG. 17.

At 2020, the method may include signaling, to the control unit, a configuration of the reconfigurable intelligent surface determined based on the first beam and the second beam. The operations of 2020 may be performed in accordance with examples as disclosed herein. In some examples, aspects of the operations of 2020 may be performed by a signaling manager 1740 as described with reference to FIG. 17.

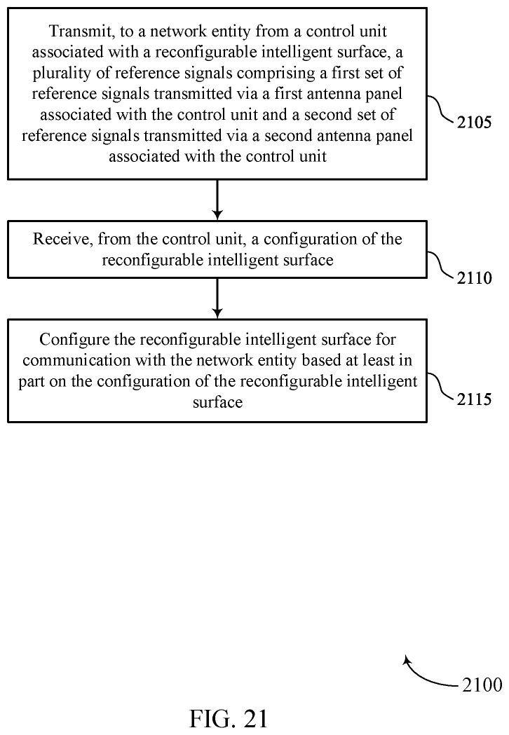

FIG. 21 shows a flowchart illustrating a method 2100 that supports multi-array design for binary beam acquisition of reconfigurable intelligent surfaces in accordance with one or more aspects of the present disclosure. The operations of the method 2100 may be implemented by a base station or its components as described herein. For example, the operations of the method 2100 may be performed by a base station 105 as described with reference to FIGS. 1 through 10 and 15 through 18. In some examples, a base station may execute a set of instructions to control the functional elements of the base station to perform the described functions. Additionally, or alternatively, the base station may perform aspects of the described functions using special-purpose hardware.

At 2105, the method may include transmitting, to a network entity from a control unit associated with a reconfigurable intelligent surface, a set of multiple reference signals including a first set of reference signals transmitted via a first antenna panel associated with the control unit and a second set of reference signals transmitted via a second antenna panel associated with the control unit. The operations of 2105 may be performed in accordance with examples as disclosed herein. In some examples, aspects of the operations of 2105 may be performed by a reference signal manager 1745 as described with reference to FIG. 17.

At 2110, the method may include receiving, from the control unit, a configuration of the reconfigurable intelligent surface. The operations of 2110 may be performed in accordance with examples as disclosed herein. In some examples, aspects of the operations of 2110 may be performed by a RIS manager 1750 as described with reference to FIG. 17.

At 2115, the method may include configuring the reconfigurable intelligent surface for communication with the network entity based on the configuration of the reconfigurable intelligent surface. The operations of 2115 may be performed in accordance with examples as disclosed herein. In some examples, aspects of the operations of 2115 may be performed by a connection manager 1755 as described with reference to FIG. 17.

The following provides an overview of aspects of the present disclosure:

Aspect 1: A method for wireless communication, comprising: receiving, from a network entity at a control unit associated with a reconfigurable intelligent surface, a plurality of reference signals via a plurality of receive beams; acquiring, via a first antenna panel associated with the control unit, a first beam of the plurality of receive beams; acquiring, via a second antenna panel associated with the control unit, a second beam of the plurality of receive beams; determining reflection coefficients of the reconfigurable intelligent surface for communication with the network entity based at least in part on the acquiring of the first beam and the acquiring of the second beam; and communicating via the reconfigurable intelligent surface based at least in part on the reflection coefficients of the reconfigurable intelligent surface.

Aspect 2: The method of aspect 1, further comprising: superposing the first beam in relation to the second beam, wherein determining the reflection coefficients is based at least in part on identifying a beam of the reconfigurable intelligent surface that corresponds to the superposing of the first beam and the second beam.

Aspect 3: The method of aspect 2, further comprising: receiving, prior to receiving the plurality of reference signals and based at least in part on the superposing of the first beam and the second beam, a channel state information reference signal resource set indicating a repetition parameter set to on and a reporting parameter set to off, wherein the plurality of reference signals comprise a plurality of channel state information reference signals.

Aspect 4: The method of aspect 3, further comprising: performing, via the first antenna panel and the second antenna panel and based at least in part on the channel state information reference signal resource set, beam sweep measurements on the plurality of reference signals received concurrently at the first antenna panel and at the second antenna panel, wherein the acquiring of the first beam and the acquiring of the second beam is based at least in part on the beam sweep measurements.

Aspect 5: The method of any of aspects 1 through 4, wherein the first antenna panel comprises a narrow panel configuration with a first inter-element spacing, and the second antenna panel comprises a wide panel configuration with a second inter-element spacing, the second inter-element spacing being larger than the first inter-element spacing.

Aspect 6: The method of aspect 5, wherein the first inter-element spacing and the second inter-element spacing are larger than an inter-element spacing of an antenna panel of the reconfigurable intelligent surface.

Aspect 7: The method of any of aspects 1 through 6, wherein the control unit comprises a first radio frequency chain for the first antenna panel and a second radio frequency chain for the second antenna panel.

Aspect 8: The method of any of aspects 1 through 7, wherein the first antenna panel and the second antenna panel have fewer antenna elements than an antenna panel of the reconfigurable intelligent surface.

Aspect 9: The method of any of aspects 1 through 8, wherein the first antenna panel or the second antenna panel, or both, have receiver capability or have receiver capability and transmitter capability.

Aspect 10: The method of any of aspects 1 through 9, wherein the control unit of the reconfigurable intelligent surface comprises logarithm N sub-arrays, each sub-array comprising multiple antenna elements that are configured in different directions.

Aspect 11: The method of aspect 10, wherein the reconfigurable intelligent surface is configured with a number of elements determined based at least in part on a value of N squared, a number of antennas at the control unit is based at least in part on a base-2 logarithm of N, and the antennas at the control unit configure the number of elements at the reconfigurable intelligent surface.

Aspect 12: A method for wireless communication, comprising: receiving, at a network entity, a plurality of reference signals transmitted from a control unit associated with a reconfigurable intelligent surface via a plurality of beams; selecting a first beam of the plurality of beams for a first antenna panel associated with the control unit; selecting a second beam of the plurality of beams for a second antenna panel associated with the control unit; and signaling, to the control unit, a configuration of the reconfigurable intelligent surface determined based at least in part on the first beam and the second beam.

Aspect 13: The method of aspect 12, wherein the configuration of the reconfigurable intelligent surface comprises reflection coefficients associated with the first antenna panel, reflection coefficients associated with the second antenna panel, a first transmit precoding matrix index associated with the first antenna panel, a second transmit precoding matrix index associated with the second antenna panel, or a transmit precoding matrix index associated with the reconfigurable intelligent surface, or any combination thereof.

Aspect 14: The method of any of aspects 12 through 13, further comprising: receiving, prior to receiving the plurality of reference signals, a configuration of the first antenna panel and the second antenna panel and a configuration of the reconfigurable intelligent surface.

Aspect 15: The method of aspect 14, further comprising: transmitting, to the control unit based at least in part on receiving the configuration of the first antenna panel and the second antenna panel, a first sounding reference signal resource set that indicates uplink beam management associated with the first antenna panel and a second sounding reference signal resource set that indicates uplink beam management associated with the second antenna panel.

Aspect 16: The method of any of aspects 14 through 15, wherein the configuration of the first antenna panel and the second antenna panel indicate an inter-element spacing of the first antenna panel, an inter-element spacing of the second antenna panel, a number of antennas associated with the first antenna panel, or a number of antennas associated with the second antenna panel, or any combination thereof, and the configuration of the reconfigurable intelligent surface indicates an inter-element spacing of elements associated with the reconfigurable intelligent surface, or a number of elements associated with the reconfigurable intelligent surface, or both.

Aspect 17: A method for wireless communication, comprising: transmitting, to a network entity from a control unit associated with a reconfigurable intelligent surface, a plurality of reference signals comprising a first set of reference signals transmitted via a first antenna panel associated with the control unit and a second set of reference signals transmitted via a second antenna panel associated with the control unit; receiving, from the control unit, a configuration of the reconfigurable intelligent surface; and configuring the reconfigurable intelligent surface for communication with the network entity based at least in part on the configuration of the reconfigurable intelligent surface.

Aspect 18: The method of aspect 17, wherein the configuration of the reconfigurable intelligent surface comprises reflection coefficients associated with the first antenna panel, reflection coefficients associated with the second antenna panel, a first transmit precoding matrix index associated with the first antenna panel, a second transmit precoding matrix index associated with the second antenna panel, or a transmit precoding matrix index associated with the reconfigurable intelligent surface, or any combination thereof.

Aspect 19: The method of any of aspects 17 through 18, further comprising: transmitting, prior to receiving the plurality of reference signals, a configuration of the first antenna panel and the second antenna panel and a configuration of the reconfigurable intelligent surface.

Aspect 20: The method of aspect 19, further comprising: receiving, from the network entity based at least in part on transmitting the configuration of the first antenna panel and the second antenna panel, a first sounding reference signal resource set that indicates uplink beam management associated with the first antenna panel and a second sounding reference signal resource set that indicates uplink beam management associated with the second antenna panel.

Aspect 21: The method of any of aspects 19 through 20, wherein the configuration of the first antenna panel and the second antenna panel indicate an inter-element spacing of the first antenna panel, an inter-element spacing of the second antenna panel, a number of antennas associated with the first antenna panel, or a number of antennas associated with the second antenna panel, or any combination thereof, and the configuration of the reconfigurable intelligent surface indicates an inter-element spacing of elements associated with the reconfigurable intelligent surface, or a number of elements associated with the reconfigurable intelligent surface, or both.

Aspect 22: An apparatus for wireless communication, comprising a processor; memory coupled with the processor; and instructions stored in the memory and executable by the processor to cause the apparatus to perform a method of any of aspects 1 through 11.

Aspect 23: An apparatus for wireless communication, comprising at least one means for performing a method of any of aspects 1 through 11.

Aspect 24: A non-transitory computer-readable medium storing code for wireless communication, the code comprising instructions executable by a processor to perform a method of any of aspects 1 through 11.

Aspect 25: An apparatus for wireless communication, comprising a processor; memory coupled with the processor; and instructions stored in the memory and executable by the processor to cause the apparatus to perform a method of any of aspects 12 through 16.

Aspect 26: An apparatus for wireless communication, comprising at least one means for performing a method of any of aspects 12 through 16.

Aspect 27: A non-transitory computer-readable medium storing code for wireless communication, the code comprising instructions executable by a processor to perform a method of any of aspects 12 through 16.

Aspect 28: An apparatus for wireless communication, comprising a processor; memory coupled with the processor; and instructions stored in the memory and executable by the processor to cause the apparatus to perform a method of any of aspects 17 through 21.

Aspect 29: An apparatus for wireless communication, comprising at least one means for performing a method of any of aspects 17 through 21.

Aspect 30: A non-transitory computer-readable medium storing code for wireless communication, the code comprising instructions executable by a processor to perform a method of any of aspects 17 through 21.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication, comprising:
receiving, from a network entity at a control unit associated with a reconfigurable intelligent surface, a plurality of reference signals via a plurality of receive beams;
acquiring, via a first antenna panel associated with the control unit, a first beam of the plurality of receive beams;
acquiring, via a second antenna panel associated with the control unit, a second beam of the plurality of receive beams;
determining reflection coefficients of the reconfigurable intelligent surface for communication with the network entity based at least in part on the acquiring of the first beam and the acquiring of the second beam; and
communicating via the reconfigurable intelligent surface based at least in part on the reflection coefficients of the reconfigurable intelligent surface.

2. The method of claim 1, further comprising:
superposing the first beam in relation to the second beam, wherein determining the reflection coefficients is based at least in part on identifying a beam of the reconfigurable intelligent surface that corresponds to the superposing of the first beam and the second beam.

3. The method of claim 2, further comprising:
receiving, prior to receiving the plurality of reference signals and based at least in part on the superposing of the first beam and the second beam, a channel state information reference signal resource set indicating a repetition parameter set to on and a reporting parameter set to off, wherein the plurality of reference signals comprise a plurality of channel state information reference signals.

4. The method of claim 3, further comprising:
performing, via the first antenna panel and the second antenna panel and based at least in part on the channel state information reference signal resource set, beam sweep measurements on the plurality of reference signals received concurrently at the first antenna panel and at the second antenna panel, wherein the acquiring of the first beam and the acquiring of the second beam is based at least in part on the beam sweep measurements.

5. The method of claim 1, wherein
the first antenna panel comprises a narrow panel configuration with a first inter-element spacing, and
the second antenna panel comprises a wide panel configuration with a second inter-element spacing, the second inter-element spacing being larger than the first inter-element spacing.

6. The method of claim 5, wherein the first inter-element spacing and the second inter-element spacing are larger than an inter-element spacing of an antenna panel of the reconfigurable intelligent surface.

7. The method of claim 1, wherein the control unit comprises a first radio frequency chain for the first antenna panel and a second radio frequency chain for the second antenna panel.

8. The method of claim 1, wherein the first antenna panel and the second antenna panel have fewer antenna elements than an antenna panel of the reconfigurable intelligent surface.

9. The method of claim 1, wherein the first antenna panel or the second antenna panel, or both, have receiver capability or have receiver capability and transmitter capability.

10. The method of claim 1, wherein the control unit of the reconfigurable intelligent surface comprises logarithm N sub-arrays, each sub-array comprising multiple antenna elements that are configured in different directions.

11. The method of claim 10, wherein
the reconfigurable intelligent surface is configured with a number of elements determined based at least in part on a value of N squared,
a number of antennas at the control unit is based at least in part on a base-2 logarithm of N, and
the antennas at the control unit configure the number of elements at the reconfigurable intelligent surface.

12. A method for wireless communication, comprising:
receiving, at a network entity, a plurality of reference signals transmitted from a control unit associated with a reconfigurable intelligent surface via a plurality of beams;
selecting a first beam of the plurality of beams for a first antenna panel associated with the control unit;
selecting a second beam of the plurality of beams for a second antenna panel associated with the control unit; and
signaling, to the control unit, a configuration of the reconfigurable intelligent surface determined based at least in part on the first beam and the second beam.

13. The method of claim 12, wherein the configuration of the reconfigurable intelligent surface comprises reflection coefficients associated with the first antenna panel, reflection coefficients associated with the second antenna panel, a first transmit precoding matrix index associated with the first antenna panel, a second transmit precoding matrix index associated with the second antenna panel, or a transmit precoding matrix index associated with the reconfigurable intelligent surface, or any combination thereof.

14. The method of claim 12, further comprising:
receiving, prior to receiving the plurality of reference signals, a configuration of the first antenna panel and the second antenna panel and a configuration of the reconfigurable intelligent surface.

15. The method of claim 14, further comprising:
transmitting, to the control unit based at least in part on receiving the configuration of the first antenna panel and the second antenna panel, a first sounding reference signal resource set that indicates uplink beam management associated with the first antenna panel and a second sounding reference signal resource set that indicates uplink beam management associated with the second antenna panel.

16. The method of claim 14, wherein
the configuration of the first antenna panel and the second antenna panel indicate an inter-element spacing of the first antenna panel, an inter-element spacing of the second antenna panel, a number of antennas associated with the first antenna panel, or a number of antennas associated with the second antenna panel, or any combination thereof, and
the configuration of the reconfigurable intelligent surface indicates an inter-element spacing of elements associated with the reconfigurable intelligent surface, or a number of elements associated with the reconfigurable intelligent surface, or both.

17. A method for wireless communication, comprising:
transmitting, to a network entity from a control unit associated with a reconfigurable intelligent surface, a plurality of reference signals comprising a first set of reference signals transmitted via a first antenna panel associated with the control unit and a second set of reference signals transmitted via a second antenna panel associated with the control unit;
receiving, from the control unit, a configuration of the reconfigurable intelligent surface; and
configuring the reconfigurable intelligent surface for communication with the network entity based at least in part on the configuration of the reconfigurable intelligent surface.

18. The method of claim 17, wherein the configuration of the reconfigurable intelligent surface comprises reflection coefficients associated with the first antenna panel, reflection coefficients associated with the second antenna panel, a first transmit precoding matrix index associated with the first antenna panel, a second transmit precoding matrix index associated with the second antenna panel, or a transmit precoding matrix index associated with the reconfigurable intelligent surface, or any combination thereof.

19. The method of claim 17, further comprising:
transmitting, prior to receiving the plurality of reference signals, a configuration of the first antenna panel and the second antenna panel and a configuration of the reconfigurable intelligent surface.

20. The method of claim 19, further comprising:
receiving, from the network entity based at least in part on transmitting the configuration of the first antenna panel and the second antenna panel, a first sounding reference signal resource set that indicates uplink beam management associated with the first antenna panel and a second sounding reference signal resource set that indicates uplink beam management associated with the second antenna panel.

21. The method of claim 19, wherein
the configuration of the first antenna panel and the second antenna panel indicate an inter-element spacing of the first antenna panel, an inter-element spacing of the second antenna panel, a number of antennas associated with the first antenna panel, or a number of antennas associated with the second antenna panel, or any combination thereof, and
the configuration of the reconfigurable intelligent surface indicates an inter-element spacing of elements associated with the reconfigurable intelligent surface, or a number of elements associated with the antenna panel of the reconfigurable intelligent surface, or both.

22. An apparatus for wireless communication, comprising:
a processor;
memory coupled with the processor; and
instructions stored in the memory and executable by the processor to cause the apparatus to:
receive, from a network entity at a control unit associated with a reconfigurable intelligent surface, a plurality of reference signals via a plurality of receive beams;
acquire, via a first antenna panel associated with the control unit, a first beam of the plurality of receive beams;
acquire, via a second antenna panel associated with the control unit, a second beam of the plurality of receive beams;
determine reflection coefficients of the reconfigurable intelligent surface for communication with the network entity based at least in part on the acquiring of the first beam and the acquiring of the second beam; and
communicate via the reconfigurable intelligent surface based at least in part on the reflection coefficients of the reconfigurable intelligent surface.

23. The apparatus of claim 22, wherein the instructions are further executable by the processor to cause the apparatus to:
superpose the first beam in relation to the second beam, wherein determining the reflection coefficients is based at least in part on identifying a beam of the reconfigurable intelligent surface that corresponds to the superposing of the first beam and the second beam.

24. The apparatus of claim 23, wherein the instructions are further executable by the processor to cause the apparatus to:
receive, prior to receiving the plurality of reference signals and based at least in part on the superposing of the first beam and the second beam, a channel state information reference signal resource set indicating a repetition parameter set to on and a reporting parameter set to off, wherein the plurality of reference signals comprise a plurality of channel state information reference signals.

25. The apparatus of claim 24, wherein the instructions are further executable by the processor to cause the apparatus to:
perform, via the first antenna panel and the second antenna panel and based at least in part on the channel state information reference signal resource set, beam sweep measurements on the plurality of reference signals received concurrently at the first antenna panel and at the second antenna panel, wherein the acquiring of the first beam and the acquiring of the second beam is based at least in part on the beam sweep measurements.

26. The apparatus of claim 22, wherein:
the first antenna panel comprises a narrow panel configuration with a first inter-element spacing, and
the second antenna panel comprises a wide panel configuration with a second inter-element spacing, the second inter-element spacing being larger than the first inter-element spacing.

27. The apparatus of claim 26, wherein the first inter-element spacing and the second inter-element spacing are larger than an inter-element spacing of an antenna panel of the reconfigurable intelligent surface.

28. The apparatus of claim 22, wherein the control unit comprises a first radio frequency chain for the first antenna panel and a second radio frequency chain for the second antenna panel.

29. The apparatus of claim 22, wherein the first antenna panel and the second antenna panel have fewer antenna elements than an antenna panel of the reconfigurable intelligent surface.

30. The apparatus of claim 22, wherein:
the first antenna panel or the second antenna panel, or both, have receiver capability or have receiver capability and transmitter capability.
